(19) United States
(12) Patent Application Publication
(10) Pub. No.: US 2018/0086548 A1
(43) Pub. Date: Mar. 29, 2018

(54) ROUNDED EXTERIOR DIAMETER ADJUSTABLE SHIPPING CONTAINER, SYSTEM, AND METHOD FOR SHIPPING FREIGHT WITH THE CONTAINER MADE OF REINFORCED THERMOPLASTIC FIBER, ARTICLES, COMPOSITIONS FOR THE MANUFACTURE OF THE ARTICLES, METHODS OF MANUFACTURE, AND ARTICLES FORMED THEREFROM

(71) Applicant: Stephan D. Heath, Highlands Ranch, CO (US)

(72) Inventor: Stephan D. Heath, Highlands Ranch, CO (US)

(21) Appl. No.: 15/714,906

(22) Filed: Sep. 25, 2017

Related U.S. Application Data
(60) Provisional application No. 62/399,805, filed on Sep. 26, 2016.

(51) Int. Cl. B65D 88/00; B65D 88/14; B65D 90/02; B64F 1/32

(52) U.S. Cl. CPC B65D 88/005; B64F 1/32; B65D 90/02; B65D 88/14

(57) ABSTRACT

Rounded exterior diameter adjustable, thermoplastic, compositions, cellulose nanofiber composition and/or carbon fiber containing shipping containers, systems, and methods for shipping freight, and more specifically to containers, trucks and/or trailers of different lengths, widths and sizes trailer, systems, and methods for shipping freight of all types from a customer's premise through land vehicles and aircraft to the premise of the consignee, preferably without the need for intermediate repackaging of the freight, where the freight shipping container can be diameter adjusted using diameter adjustable sidewall sections that are configured to conform to the interior shape of an aircraft fuselage, such that the shipping container can be adjusted to have a size and shape which is compatible with a wide variety of standard-sized trucks and aircraft, wherein the rounded, exterior diameter adjustable shipping container is made from a composition comprising a combination of one or more of a plurality of reinforcing fibers including carbon or graphite or graphene fibers; optionally a plurality of thermoplastic fibers; optionally a plurality of cellulose nanofibers; optionally a plurality of polymeric binder fibers; and continuous spaced carrier fibers; and methods for using the shipping containers.

### FIELD

The present subject matter relates to containers, systems, and methods for shipping freight, and more specifically to containers, trucks and/or trailers of different lengths, widths and sizes, systems, and methods for shipping freight of all types from a point of origin using both land vehicles and aircraft to a destination point, wherein the container is optionally comprised a thermoplastic, compositions, cellulose nanofiber composition and/or carbon fiber composition.

### BACKGROUND

The efficient, safe, and secure shipment of freight, including but not limited to correspondence, materials, goods, components, and commercial products, is an important component in today's business, particularly in view of the international nature of most business enterprises. Freight often is shipped nationally and internationally by several different transportation devices, such as trucks, trains, ships, and airplanes. Before the freight reaches its destination, it is often handled by several different entities, such as truck companies, intermediate consolidators, railways, shipping companies, and airlines.

While a number of methods and systems for shipping freight are presently available, the shipment of large volumes of freight typically involves a complex and inefficient transfer and repackaging of freight before it ultimately is received by the consignee. By way of example only, parcels of freight are typically picked up by one entity and brought to a transfer point where the goods are consolidated with other freight into boxes or containers. These boxes and containers, often containing freight of a variety of different customers, are then shipped by land, sea, or air to another site where the parcels of freight are unconsolidated, reloaded, and then delivered to the consignee. Throughout this process, different entities have custodial control of the freight, increasing the prospects of mishandling or error. This complex process results in obvious inefficiencies and increased expenses. It also increases the prospects for potential damage to or loss of the freight as it is transported from the customer's premise to the premise of the consignee.

There accordingly remains a continuing need for materials useful in the manufacture of reinforced thermoplastic thermoformed articles that conform more consistently and faithfully to the mold shape on which they are formed. Yet a further advantage would be for thermoformed articles to have one or more of toughness, lighter weight, weatherability, stability, chemical resistance, and ease of cleaning.

### SUMMARY

The present subject matter relates to one or more of diameter adjustable, fiber comprising, shipping containers, systems, and methods for shipping freight, and more specifically to containers, trucks and/or trailers of different lengths, widths and sizes, including, but not limited to single, double, triple, or more of one or more of 16, 16.5, 20, 24, 28, 28.5, 33, 40, 45, 48, 51, 53, 55, 60, 65-foot long, or 5, 5.03, 6, 6.1, 6.5, 7, 7.5, 7.82, 8, 8.5, 8.8, 9, 9.5, 10, 10.5, 11, 11.5, 12, 12.5, 13, 13.1, 13.5, 13.6, 13.7, 14, 14.5, 15, 15.5, 15.6, 16, 16.1, 16.5, 17, 17.5, 18, 18.5, 19, 19.5, 20, 20.5, 21, 21.5, 22, 23, 24, 25, 26, 27 meter long, trailers, trailer systems, cargo containers or cargo container systems, between 2 and 40 feet, or 0.5 and 13 meters in height (e.g., but not limited to 2, 4, 6, 8, 10, 12, 14, 16, 18, 20, 22, 24, 26, 28, 30, 32, 34, 36, 38 or 40 feet or 0.5, 1, 1.5, 2, 2.5, 3, 3.5, 4, 4.3, 5, 5.03, 6, 6.5, 7, 7.5, 8, 9, 10, 11, 12, or 13 meters); and, e.g., but not limited to 2 and 20 feet, or 0.5 and 7 meters in width (e.g., but not limited to 2, 4, 6, 8, 10, 12, 14, 16 feet or 0.5, 1, 1.5, 2, 2.5, 3, 3.5, 4, 4.3, 5, 5.03, 6, 6.5, or 7 meters), and methods for shipping freight of all types from a point of origin using both land and water vehicles and aircraft to a destination point, wherein the container is optionally comprised a thermoplastic, compositions, cellulose nanofiber composition and/or carbon fiber composition.

The present subject matter optionally comprises a diameter adjustable shipping container configured to be conformable to an interior space of an aircraft fuselage, the container having rounded exterior wall components, the rounded, exterior diameter adjustable shipping container comprising: rounded exterior sidewall sections comprising a plurality of reinforcing fibers and carrier fibers arranged in one or more layers; wherein the reinforcing or carrier fibers comprise graphite or graphene or carbon fibers; a base, a roof, at least two pair of opposed side walls comprising at least two of said exterior sidewall sections, and at least one pair of opposed end walls, one of said end walls including at least one opening for the loading and removal of freight, said rounded, exterior diameter adjustable shipping container and said opening configured to permit the loading and unloading of freight to and from the container by a conventional forklift truck; wherein said rounded, exterior diameter adjustable shipping container is configured, with loaded freight as at least one freight loaded shipping container, truck or trailer, to be loaded and locked onto a freight truck or train for transport to an airport, and wherein said at least one diameter adjustable shipping container is configured to be diameter adjusted, using a reconfiguration of said rounded exterior sidewall sections of said freight loaded shipping container, truck or trailer, to conform to at least a portion of said interior space of an aircraft fuselage adjacent to said freight loaded shipping container, truck or trailer when loaded onto said aircraft fuselage.

The developments hereof optionally further comprises one or more of:
wherein at least one of the base, roof, and opposed side walls comprise a plurality of reinforcing fibers and carrier fibers arranged in one or more layers; wherein the reinforcing or carrier fibers comprise graphite or graphene or carbon fibers;
wherein the rounded exterior sidewall sections, or one or more of the base, the roof, and the at least two pair of opposed side walls, further comprise a plurality of thermoplastic fibers; and wherein said combination of one or more of reinforcing, carrier, and or thermoplastic fibers is arranged in one or more layers;
wherein the carrier fibers are configured to be present and spaced on, and substantially transit, a surface of at least one such layer; and said composition does not contain a scrim carrier layer;
wherein the spaced, continuous carrier fibers transit the surface of the layer as substantially parallel fibers in a machine or a cross-machine direction;
wherein the rounded exterior sidewall sections comprises: from 35 to 65 wt. % of the reinforcing fibers; and from 35 to 65 wt. % of the thermoplastic fibers; each based on the combined weight of the reinforcing fibers and the thermoplastic fibers;
wherein the reinforcing fibers further comprise one or more metal fibers, metallized inorganic fibers, metallized synthetic fibers, glass fibers, cellulose nanofibers, carbon fibers, ceramic fibers, mineral fibers, basalt fibers, or polymer fibers having a Tg at least 150 degrees C. higher than the polyimide, or a combination thereof;
wherein the reinforcing fibers comprise glass fibers;
wherein the thermoplastic fiber is selected from one or more of polyetherimide, polyetherimide sulfone, polyetherimide-siloxanes, polycarbonate, polycarbonate-siloxane, polyester carbonate, polyester carbonate-siloxane, polyesters, polyethylene terephthalate, polybutylene terephthalate, polyolefin, polyethylene, polypropylene, polyamides, and high performance polymers, polybenzimidazole, and liquid crystalline polymers;
wherein the thermoplastic fiber comprises a polyetherimide; and/or
wherein the rounded exterior sidewall sections further comprises a polymeric binder fiber.

The developments optionally further comprise one or more of:
wherein the binder fiber is selected from a polyamide, polysiloxane, polysiloxane-polyester carbonate copolymer, polyester, polycarbonate, polyester-polyetherimide blend, bicomponent fiber of any of the foregoing, or a combination thereof;
wherein the polysiloxane-polyester carbonate copolymer comprises polysiloxane units comprising from 4 to 50 siloxane units, wherein the siloxane units are present in an amount of 0.2 to 10 wt. % of the total weight of the polysiloxane-polyester carbonate copolymer, and polyester-polycarbonate units comprising, based on the polyester-polycarbonate units from 50 to 100 mole percent of acrylate ester units, from more than 0 to less than 50 mole percent aromatic carbonate units, from more than 0 to less than 30 mole percent resorcinol carbonate units, and from more than 0 to less than 35 mole percent bisphenol carbonate units; and wherein the polysiloxane-polyester carbonate copolymer composition has a 2 minute integrated heat release rate of less than or equal to 65 kilowatt-minutes per square meter (kW-min/m²) and a peak heat release rate of less than 65 kilowatts per square meter (kW/m²) as measured using the method of FAR F25.4, in accordance with Federal Aviation Regulation FAR 25.853 (d);
wherein the acrylate ester units are isophthalate-terephthalate-resorcinol ester units;
wherein the average fiber length of the reinforcing fibers is from 5 to 75 millimeters and the average fiber diameter of the reinforcing fibers is from 5 to 125 micrometers; the average fiber length of the thermoplastic fibers is from 5 to 75 millimeters, and the average fiber diameter of the polyimide fibers is from 5 to 125 micrometers;
further comprising thermoplastic fibers of sub-micron diameter;
further comprising an aqueous fluid.

The components of a container or trailer hereof can optionally comprise one or more configurations, components, materials, and the like of modular, insulated, carbon fiber, micro fiber, carbon fiber reinforced panels, walls, or components, as known, e.g., U.S. Pat. Nos. 6,161,714, 5,449,081, 5,396,932, 5,360,129, 5,277,973, 5,255,806, 4,784,920, 4,622,086, and/or 4048360, each of which is entirely incorporated by reference as to one or more of these aspects hereof.

The components of a container or trailer hereof can optionally comprise one or more configurations, components, materials, and the like of modular, insulated, cellulose nanofiber reinforced panels, walls or components, as known, each of which is entirely incorporated by reference as to one or more of these aspects.

The components of a container or trailer hereof can optionally comprise one or more configurations, components, materials, and the like of modular, insulated, graphite fiber reinforced panels, walls or components, as known, each of which is entirely incorporated by reference as to one or more of these aspects.

The components of a container or trailer hereof can optionally comprise one or more configurations, components, materials, and the like of modular, insulated, graphene fiber reinforced panels, walls or components, as known, each of which is entirely incorporated by reference as to one or more of these aspects.

The present subject matter optionally comprises a method of shipping freight using at least one freight loaded shipping container, truck or trailer comprising a diameter adjustable shipping container according hereto, wherein the diameter adjustable shipping container is configured to be conformable to an interior space of an aircraft fuselage, the container having rounded exterior wall components, comprising the steps of:
(a) providing at least one diameter adjustable shipping container;
(b) adjusting that at least one diameter adjustable shipping container to be diameter adjusted, using a reconfiguration of said rounded exterior sidewall sections of said diameter adjustable shipping container, to conform to at least a portion of said interior space of an aircraft fuselage adjacent to said diameter adjustable shipping container when loaded onto said aircraft fuselage;
(c) loading freight into said at least one diameter adjustable shipping container adjusted according to step (b) and securing the freight in the rounded, exterior diameter adjustable shipping container to provide the at least one freight loaded shipping container, truck or trailer;
(d) transporting said at least one freight loaded shipping container, truck or trailer, in a secured state, to an aircraft comprising said aircraft fuselage; and
(e) transferring and loading said at least one freight loaded shipping container, truck or trailer into said aircraft fuselage such that said freight loaded shipping container, truck or trailer conforms to at least a portion of said interior space of said aircraft fuselage adjacent to said freight loaded shipping container, truck or trailer when loaded onto said aircraft fuselage.

The present subject matter optionally further comprises one or more of:
transporting by aircraft said at least one freight loaded shipping to a designated airport; and transferring said at least one freight loaded shipping container, truck or trailer to a land vehicle;
placing a bar code designation on the freight loaded shipping container, truck or trailer before it is transported according to step (d);
placing transactional information regarding the freight and its intended destination into a computer memory; and/or
transferring and transporting the at least one freight loaded shipping container, truck or trailer to and with a truck having a cab and a removable trailer, moving the removable trailer of the truck and the freight loading shipping container, driving the cab away, and returning and then picking up the removable trailer and freight loaded shipping container, truck or trailer after the freight loading shipping container is loaded.

The present subject matter relates to a composition for the manufacture of a porous, compressible article, such as a shipping container, the composition comprising a combination of: a plurality of reinforcing fibers; a plurality of thermoplastic fibers, such as carbon fibers; and said combination of fibers is arranged in one or more layers; and further comprising: a plurality of spaced continuous carrier fibers, which are present on, and substantially transit, a surface of at least one such layer; and said composition does not contain a scrim carrier layer.

The present subject matter optionally relates to a method for forming a porous article such as a shipping container, the method comprising: forming a layer comprising a suspension of the composition in liquid; at least partially removing the liquid from the suspension to form a web; heating the web under conditions sufficient to remove any remaining liquid from the web and to melt the thermoplastic fibers; and cooling the heated web to form the porous mat, wherein the porous article comprises a network of the reinforcing fibers and the thermoplastic fibers and a plurality of spaced carrier fibers on a surface of the porous mat.

The present subject matter optionally relates to a porous article, such as a rounded, exterior diameter adjustable shipping container, comprising: a network of a plurality of reinforcing fibers and a plurality of thermoplastic fibers deposited on the network comprising melted and cooled thermoplastic fibers, and a plurality of spaced continuous carrier fibers which transit said porous article, either on a surface of a layer of said network, or at the interface between two layers of said network.

An aspect hereof is to provide a container, system, and method for shipping freight, particularly large volumes of freight, which represent significant improvements over prior devices, systems and/or methods.

Another aspect hereof is to provide a container, system, and method for shipping freight, which permits the freight of a particular customer to be loaded at the customer's premise and then secured, and preferably sealed, before it leaves the customer's premise.

Yet another aspect hereof is to provide a container, which can accept and safely hold standard-sized loads-of freight and has a size and shape, which is compatible with a wide variety of standard-sized trucks and aircraft. Such a shape also provides aerodynamic and friction and wind reducing shape that increases the efficiency of the trailer when carried by a truck or cab or other pulling vehicle, such that the aerodynamic or curved shape can increase one or more of fuel efficiency, decrease rolling friction, increase speed with less torque, improved handling and stability, and/or other improvement in trailer pulling efficiency. Such shapes of the exterior surface of the container or trailer can optionally include one or more portions as rounded, cone, polygonal, spherical, square, tubular, funnel, rectangle, triangular, oblong, oval, flat, curved, convex, concave, flat bottom, and the like, and can optionally further contain one or more boat tails to reduce wind drag. The shape of the container or trailer can be determined based on the shape of the carrier or cargo hold of the vehicle transporting the container or trailer, and can include providing shapes that stack or conform to teach other to maximize the number of containers that can be placed within the container, trailer, carrier and/or cargo hold. Such shapes and logistics systems and methods are well known, e.g., at provided in U.S. Pat. No. 8,788,085, 20080167817, U.S. Pat. No. 8,066,460, 20110020090, U.S. Pat. Nos. 9,340,286, 6,902,368, each of which are entirely incorporated herein by reference as to these aspects hereof.

Cargo roller systems are optionally included in one or more aspects hereof, as well known, e.g., but not limited to, the following US patents and patent applications, which are each entirely incorporated by reference herein, US: U.S. Pat. Nos. 9,260,176, 6,394,392, 4,860,973, 6,557,800, 6,616,103, 9,428,284, 7,699,267, 7,954,760, 8,459,592, 7,770,844, 7,261,257, 8,864,079, 5,184,366, 5,601,201, 4,747,504, 7,845,898, 7,891,608, 6,616,100, 7,534,082, 8,162,542, 4,036,455, 4,544,319, 4,039,163, 3,612,316, 8,788,085, 4,235,399, 4,077,532, and 9,376,210.

Cargo logistics systems are optionally included in one or more aspects hereof as well known, e.g., but not limited to, the following US patents and patent applications, which are each entirely incorporated by reference herein, US: U.S. Pat. Nos. 7,100,827, 7,003,374, 2004/0237870, 2014/0036072, U.S. Pat. Nos. 7,320,289, 8,515,656, 2010/0100225, 2010/0176961, U.S. Pat. Nos. 7,198,227, 8,622,298, 7,344,109, 8,308,107, 7,196,622, 5,803,699, and 6,129,025.

Still another aspect hereof is to provide a container, system, and method for shipping freight, which permits a single shipper to be solely responsible for the custodial control of the freight from the customer's premises to the consignee.

Additional aspects and advantages hereof will be set forth in part in the description which follows and in part will be obvious from the description, or may be learned by practice hereof. The objects and advantages of the subject matter hereof will be realized and attained by the elements, methods, and combinations particularly pointed out in the appended claims.

To achieve the aspects and in accordance with the purposes hereof, as embodied and broadly described herein, the subject matter comprises a rounded, exterior diameter adjustable shipping container for holding and transporting freight, the rounded, exterior diameter adjustable shipping container comprising a base, a pair of opposed side walls, and a pair of opposed end walls, one of said end walls including an opening for the loading and removal of freight, the container and the opening being sufficiently large to permit the loading and removal of freight to and from the container by a conventional forklift truck, the container having a length of approximately 13 feet.

Preferably the rounded, exterior diameter adjustable shipping container has a door which can close the opening and which can be selectively locked to secure the freight in the box. The container preferably has a height of 8 feet, a width of 8 feet, and can contain at least 12 standard-sized pallets of freight. The container in its preferred form is sized and shaped to fit laterally or longitudinally into a variety of wide-bodied airplanes and longitudinally into a variety of conventional trucks and truck trailers.

The subject matter hereof may further comprise a system for shipping freight from the premise of a customer to the premise of the ultimate recipient by transportation including one or more land vehicles, the system comprising an inventory of identical rounded, exterior diameter adjustable shipping containers for holding the freight to be shipped, each container having a length of approximately 13 feet and including a base, a roof, a pair of opposed side walls, a pair of opposed end walls, and an opening formed in one of the end walls. The opening is sufficiently large to permit a conventional forklift truck to load and unload freight into and out of the container. The one or more land vehicles removably support at least one rounded, exterior diameter adjustable shipping container and transport the at least one container to and from the customer's premise.

In an embodiment of a system hereof, the system also includes an aircraft for removably supporting at least one rounded, exterior diameter adjustable shipping container and transporting the at least one rounded, exterior diameter adjustable shipping container from one airport to another. The system also preferably includes locking devices on the vehicle and the aircraft which engage a portion of the rounded, exterior diameter adjustable shipping container and secure the container on the vehicles and/or aircraft, as the containers are being transported. The system also preferably includes scanning or computer devices for placing transactional information regarding the freight and its intended destination into a computer memory, which information can be used to track the freight and ensure that it is properly shipped, insured, and passed through customs or any other governmental or jurisdictional transfer.

In addition, the subject matter hereof includes a method of shipping freight directly from a customer's premise to the premise of the consignee comprising the steps of transporting to a customer's premises at least one rounded, exterior diameter adjustable shipping container having a base, a roof, a pair of opposed side walls, and a pair of opposed end walls, one of the end walls including an opening for the loading and removal of freight, the container and the opening being sufficiently large to permit the loading and unloading of freight to and from the container by a conventional forklift truck. At the customer's premise freight is loaded into the at least one rounded, exterior diameter adjustable shipping container and the freight is secured in the rounded, exterior diameter adjustable shipping container. One or more land vehicles transport the at least one rounded, exterior diameter adjustable shipping container from the customer's premise to the premise of the consignee of freight.

The method hereof also can include the steps of transporting the at least one rounded, exterior diameter adjustable shipping container and its loaded freight, in a secured state, from the customer's premise to an aircraft and loading one or more of the secured rounded, exterior diameter adjustable shipping container into the aircraft. The aircraft transports the at least one such secured rounded, exterior diameter adjustable shipping container to a designated airport, where the at least one rounded, exterior diameter adjustable shipping container is transferred to a land vehicle for transporting the freight to the consignee.

Preferably, all of the above steps, except the step of loading or unloading the rounded, exterior diameter adjustable shipping container, are performed by a single entity which is responsible for the custody and control of the rounded, exterior diameter adjustable shipping container and any freight in the container during the performance of these steps. In certain methods hereof, the rounded, exterior diameter adjustable shipping container, with or without a movable trailer for the container, is left at the customer's premises and placed solely in the customer's custody and control while the customer's freight is loaded into the rounded, exterior diameter adjustable shipping container.

The use of different size trailers in single or combinations, such as 1, 2, 3, 4, or 5 trailers in tandem can optionally be included herein, such as 1, 2, 3, 4, or 5 of one or more of 28, 28.5, 33, 32, 38, 40, 46, 50, 52, and/or 53, ft. trailers. It has recently been found, e.g., that different sizes can increase efficiency, and provide other benefits, of transport, e.g., by switching from 28′ doubles to 33′ doubles. Such benefits can include one or more of reducing pavement and/or bridge damage; the number of truck trips, congestion, and emissions, and can increase productivity and competition.

It is to be understood that both the foregoing general description and the following detailed description are exemplary and explanatory only and are not restrictive of the subject matter, as claimed herein.

### BRIEF DESCRIPTION OF THE DRAWINGS

The accompanying drawings, which are incorporated in and constitute a part of this specification, illustrate embodiments hereof and together with the description, serve to explain the principles of the present subject matter.

FIG. 1 is a schematic drawing illustrating elements and principles of prior freight transporting systems.

FIG. 2 is another schematic drawing illustrating components and principles hereof.

FIG. 2A is a perspective schematic view illustrating airport operations in accordance herewith.

FIG. 3 is an exploded perspective drawing illustrating an embodiment of a shipping container hereof.

FIG. 3A is a perspective view of the rounded, exterior diameter adjustable shipping container after loading and sealing.

FIG. 4 is an illustration of a truck and removable trailer for transporting the rounded, exterior diameter adjustable shipping container hereof to and from a customer's premise.

FIG. 5 is a schematic view, in perspective, showing a shipping container being loaded by a forklift and transfer of the loaded container to the truck shown in FIG. 4.

FIGS. 6A through 6C are perspective views of alternative embodiments of the truck shown in FIG. 4.

FIGS. 7A through 7F are drawings illustrating the placement of the rounded, exterior diameter adjustable shipping container hereof into several different aircraft.

FIG. 8 is a drawing illustrating the placement of the rounded, exterior diameter adjustable shipping container hereof into several different trucks.

FIG. 9 is a plan view of the surface of a porous mat showing the continuous spaced carrier fibers applied as unidirectional fibers in the machine direction.

FIG. 10 is a plan view of the surface of a porous mat showing the continuous carrier fiber applied in a diagonal traversing pattern at an angle relative to the machine direction.

### DETAILED DESCRIPTION

Reference will now be made in detail to non-limiting examples of the present subject matter, examples of which are illustrated in the accompanying drawings.

The present subject matter optionally provides a rounded exterior diameter adjustable, thermoplastic, compositions, cellulose nanofiber composition and/or carbon fiber containing shipping containers, systems, and methods for shipping freight, and more specifically to containers, trucks and/or trailers of different lengths, widths and sizes, including, one or more of a turnpike double as two 28, 28.5, 33, 32, 38, 40, 46, 50, 51, 52, and/or 53, ft. trailers or longer, including a 53 foot turnpike double; Rocky Mountain doubles as one 28, 28.5, 33, 32, 38, 40, 46, 50, 51, 52, and/or 53, ft. mailer or longer and another shorter trailer such as a 28, 28.5, 33, 32, 38, 40, 46, 50, 51, or 52-foot; a Rocky Mountain Double as three 28, or more, such as a 28.5, 33, 32, 38, 40, 46, 50, 51, 52, and 53, ft.; a Triple trailer—as three 28.5 ft. pups or trailers, or 28, 33, 32, 38, 40, 46, 50, 51, 52, and 53, ft.; a B-Train, as 33 foot max twin trailer that shares a tridem wheel set between the front and back trailer; a B-train as two or three 33 foot trailers; and/or STAA doubles pups as two 28.5 ft. trailers, or as two 33, 32, 38, 40, 46, 50, 51, 52, and 53, ft. trailer, systems, and methods for shipping freight of all types from a customer's premise through land vehicles and aircraft to the premise of the consignee, preferably without the need for intermediate repackaging of the freight, where the freight shipping container hereof can be diameter adjusted using diameter adjustable sidewall sections that are configured to conform to the interior shape of an aircraft fuselage, such that the shipping container can be adjusted to have a size and shape which is compatible with a wide variety of standard-sized trucks and aircraft, wherein the rounded, exterior diameter adjustable shipping container is made from a composition comprising a combination of one or more of a plurality of reinforcing fibers including carbon or graphite or graphene fibers; optionally a plurality of thermoplastic fibers; optionally a plurality of cellulose nanofibers; optionally a plurality of polymeric binder fibers; and continuous spaced carrier fibers; and methods for using the shipping containers. Such a shape also provides aerodynamic and friction and wind reducing shape that increases the efficiency of the trailer when carried by a truck or cab or other pulling vehicle, such that the aerodynamic or curved shape can increase one or more of fuel efficiency, decrease rolling friction, increase speed with less torque, improved handling and stability, and/or other improvement in trailer pulling efficiency.

The subject matter hereof optionally comprises a diameter adjustable shipping container configured to be conformable to an interior space of an aircraft fuselage, the container having rounded exterior wall components, the rounded, exterior diameter adjustable shipping container comprising: rounded exterior sidewall sections comprising a plurality of reinforcing fibers and carrier fibers arranged in one or more layers; wherein the reinforcing or carrier fibers comprise graphite or graphene or carbon fibers; a base, a roof, at least two pair of opposed side walls comprising at least two of said exterior sidewall sections, and at least one pair of opposed end walls, one of said end walls including at least one opening for the loading and removal of freight, said rounded, exterior diameter adjustable shipping container and said opening configured to permit the loading and unloading of freight to and from the container by a conventional forklift truck; wherein said rounded, exterior diameter adjustable shipping container is configured, with loaded freight as at least one freight loaded shipping container, truck or trailer, to be loaded and locked onto a freight truck or train for transport to an airport, and wherein said at least one diameter adjustable shipping container is configured to be diameter adjusted, using a reconfiguration of said rounded exterior sidewall sections of said freight loaded shipping container, truck or trailer, to conform to at least a portion of said interior space of an aircraft fuselage adjacent to said freight loaded shipping container, truck or trailer when loaded onto said aircraft fuselage.

The subject matter hereof optionally further comprises one or more of:
wherein at least one of the base, roof, and opposed side walls comprise a plurality of reinforcing fibers and carrier fibers arranged in one or more layers; wherein the reinforcing or carrier fibers comprise graphite or graphene or carbon fibers;
wherein the rounded exterior sidewall sections, or one or more of the base, the roof, and the at least two pair of opposed side walls, further comprise a plurality of thermoplastic fibers; and wherein said combination of one or more of reinforcing, carrier, and or thermoplastic fibers is arranged in one or more layers;
wherein the carrier fibers are configured to be present and spaced on, and substantially transit, a surface of at least one such layer; and said composition does not contain a scrim carrier layer;
wherein the spaced, continuous carrier fibers transit the surface of the layer as substantially parallel fibers in a machine or a cross-machine direction;
wherein the rounded exterior sidewall sections comprises: from 35 to 65 wt. % of the reinforcing fibers; and from 35 to 65 wt. % of the thermoplastic fibers; each based on the combined weight of the reinforcing fibers and the thermoplastic fibers;
wherein the reinforcing fibers further comprise one or more metal fibers, metallized inorganic fibers, metallized synthetic fibers, glass fibers, cellulose nanofibers, carbon fibers, ceramic fibers, mineral fibers, basalt fibers, or polymer fibers having a Tg at least 150 degrees C. higher than the polyimide, or a combination thereof;
wherein the reinforcing fibers comprise glass fibers;
wherein the thermoplastic fiber is selected from one or more of polyetherimide, polyetherimide sulfone, polyetherimide-siloxanes, polycarbonate, polycarbonate-siloxane, polyester carbonate, polyester carbonate-siloxane, polyesters, polyethylene terephthalate, polybutylene terephthalate, polyolefin, polyethylene, polypropylene, polyamides, and high performance polymers, polybenzimidazole, and liquid crystalline polymers;
wherein the thermoplastic fiber comprises a polyetherimide; and/or
wherein the rounded exterior sidewall sections further comprises a polymeric binder fiber.

The subject matter hereof optionally further comprises one or more of:
wherein the binder fiber is selected from a polyamide, polysiloxane, polysiloxane-polyester carbonate copolymer, polyester, polycarbonate, polyester-polyetherimide blend, bicomponent fiber of any of the foregoing, or a combination thereof;
wherein the polysiloxane-polyester carbonate copolymer comprises polysiloxane units comprising from 4 to 50 siloxane units, wherein the siloxane units are present in an amount of 0.2 to 10 wt. % of the total weight of the polysiloxane-polyester carbonate copolymer, and polyester-polycarbonate units comprising, based on the polyester-polycarbonate units from 50 to 100 mole percent of acrylate ester units, from more than 0 to less than 50 mole percent aromatic carbonate units, from more than 0 to less than 30 mole percent resorcinol carbonate units, and from more than 0 to less than 35 mole percent bisphenol carbonate units; and wherein the polysiloxane-polyester carbonate copolymer composition has a 2 minute integrated heat release rate of less than or equal to 65 kilowatt-minutes per square meter (kW-min/m²) and a peak heat release rate of less than 65 kilowatts per square meter (kW/m²) as measured using the method of FAR F25.4, in accordance with Federal Aviation Regulation FAR 25.853 (d);
wherein the acrylate ester units are isophthalate-terephthalate-resorcinol ester units;
wherein the average fiber length of the reinforcing fibers is from 5 to 75 millimeters and the average fiber diameter of the reinforcing fibers is from 5 to 125 micrometers; the average fiber length of the thermoplastic fibers is from 5 to 75 millimeters, and the average fiber diameter of the polyimide fibers is from 5 to 125 micrometers;
further comprising thermoplastic fibers of sub-micron diameter;
further comprising an aqueous fluid.

The subject matter hereof optionally comprises a method of shipping freight using at least one freight loaded shipping container, truck or trailer comprising a diameter adjustable shipping container according to claim 1, wherein the diameter adjustable shipping container is configured to be conformable to an interior space of an aircraft fuselage, the container having rounded exterior wall components, comprising the steps of:
(a) providing at least one diameter adjustable shipping container according to claim 1;
(b) adjusting that at least one diameter adjustable shipping container to be diameter adjusted, using a reconfiguration of said rounded exterior sidewall sections of said diameter adjustable shipping container, to conform to at least a portion of said interior space of an aircraft fuselage adjacent to said diameter adjustable shipping container when loaded onto said aircraft fuselage;
(c) loading freight into said at least one diameter adjustable shipping container adjusted according to step (b) and securing the freight in the rounded, exterior diameter adjustable shipping container to provide the at least one freight loaded shipping container, truck or trailer;
(d) transporting said at least one freight loaded shipping container, truck or trailer, in a secured state, to an aircraft comprising said aircraft fuselage; and
(e) transferring and loading said at least one freight loaded shipping container, truck or trailer into said aircraft fuselage such that said freight loaded shipping container, truck or trailer conforms to at least a portion of said interior space of said aircraft fuselage adjacent to said freight loaded shipping container, truck or trailer when loaded onto said aircraft fuselage.

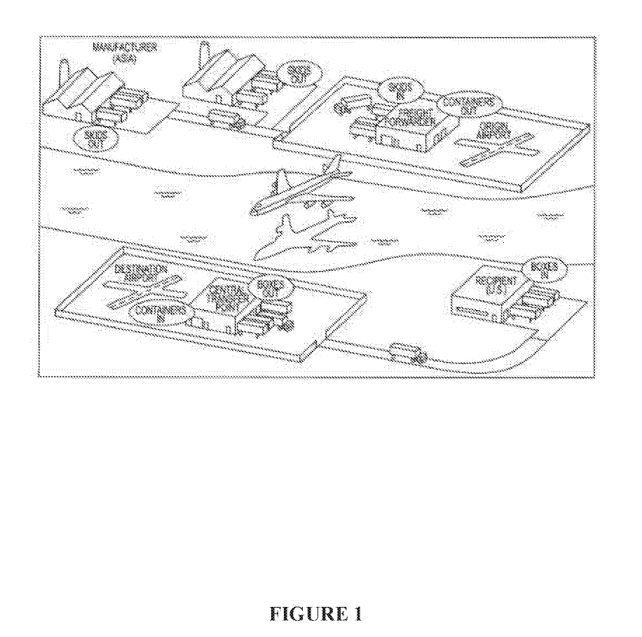

As will be explained in more detail below, the containers, systems, and methods hereof represent significant improvements over present containers systems and methods, where items of freight to be shipped are transported by one entity from a customer's premise to a central area where the items are then consolidated into a larger container, which in turn is transported and later unconsolidated, often by different entities. For example, in conventional systems, as shown in FIG. 1, parcels of freight from a customer are transported to a freight forwarder who in turn takes freight from a variety of different customers at a central location and then sorts and repackages the freight in shipping containers to be transported by land, air, train, or ship to another central transfer point. At that central transfer point, the consolidated freight in the container is removed and sorted and/or repackaged, before it is then transferred to the consignee.

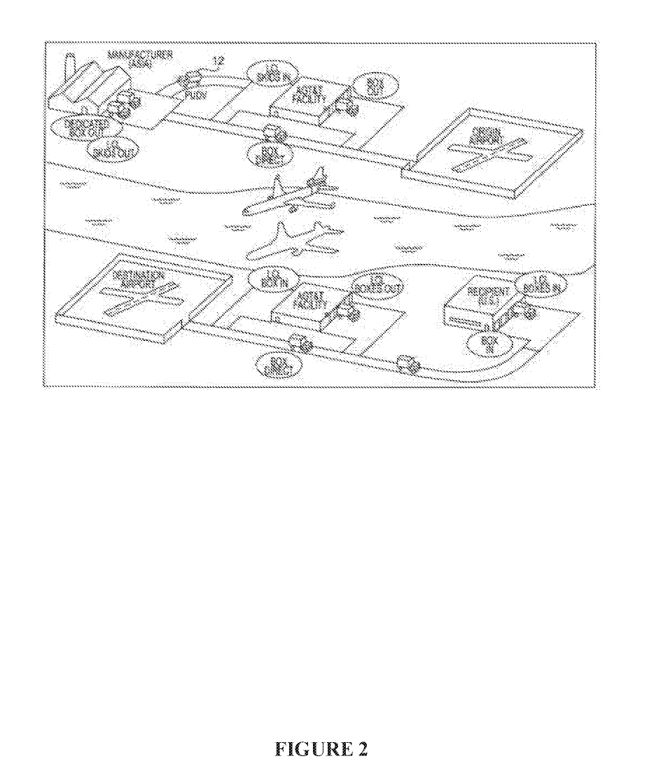

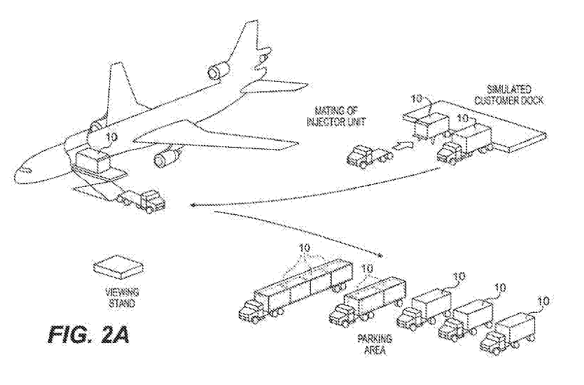

In a container, system, and/or method hereof, which is schematically illustrated in FIG. 2, the rounded, exterior diameter adjustable shipping container to be described, by itself, is brought to a customer's premise where it will be loaded, inventoried, locked, and sealed. As shown, the container is transferred to the customer's premise by a truck. The container hereof is designed to rest at a customer's loading facility, or alternately with the customer's building, where it will be loaded, using any of a variety of premise loading devices, including forklift trucks. Alternatively, freight can be loaded by hand into the container. The container is designed to allow a forklift to go inside the container to position the freight, whether on skids or otherwise packaged, into the rounded, exterior diameter adjustable shipping container.

The rounded, exterior diameter adjustable shipping container preferably is sized and configured to accept the standard size pallet loads and to fit within a wide variety of conventional trucks and aircrafts, without sacrificing efficient loading of the transporting vehicle or aircraft. After the customer's freight is loaded, the rounded, exterior diameter adjustable shipping container can be locked and sealed at the customer's location and most often transferred to the consignee in a locked and sealed state. Consequently, the present subject matter obviates the need for rehandling and repackaging by freight forwarder or shipper. Thus, the container can be transported directly from a customer's premises to the consignee by truck, or from a truck to an airport, flown to a different airport, and transferred directly from the other airport to the premise of the consignee.

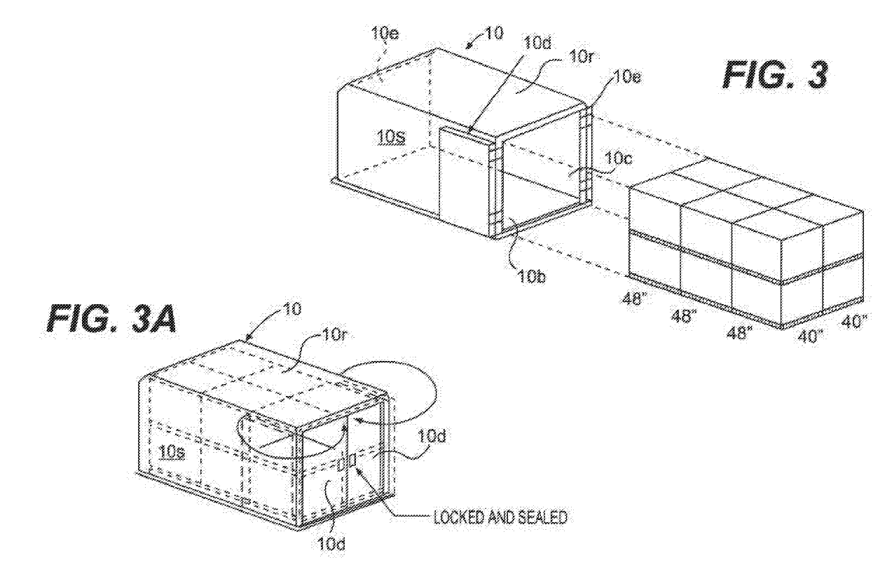

With reference to FIGS. 2A-5 and 8 of the drawings, the freight shipped according hereto is securely held throughout the transfer process in an integral container 10 which is sized and configured to accept standard loads of freight and be accepted and efficiently transported by conventional trucks and aircraft. As shown in FIGS. 3 and 3A, the container 10 has a base 10b, a roof 10r, a pair of opposed sidewalls 10s, and a pair of opposed end walls 10e. It preferably has outer dimensions of 13 feet by 8 feet by 8 feet. The container has an opening 10o at one end for loading and unloading of freight. The container 10 and the opening 10o are sufficiently large to permit the loading and unloading of freight to and from the container by a conventional forklift truck. The container also includes doors 10d designed to securely close the opening 10o, once the freight is loaded, thereby securing the freight within the container. The container also includes a locking feature (not shown), which permits the doors to be locked, thereby preventing unauthorized access to any freight loaded in the container.

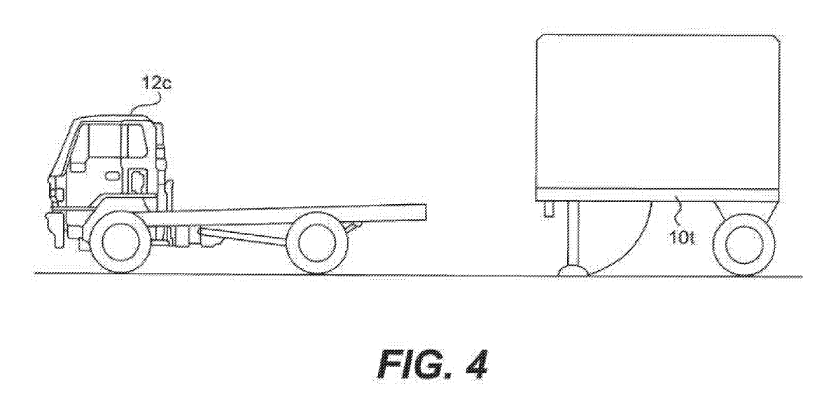

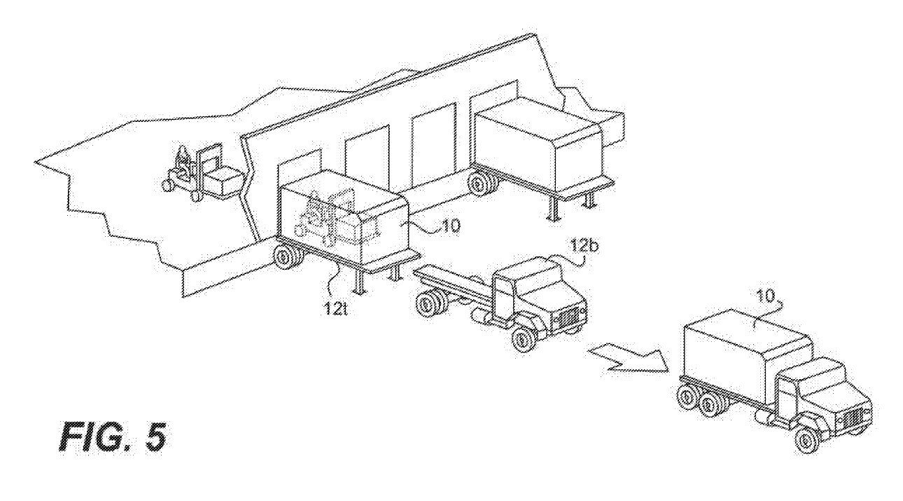

As shown in FIG. 2, the rounded, exterior diameter adjustable shipping container hereof is transported directly to a customer's premise by a truck 12, preferably a truck 12 as shown in FIG. 4, having a cab 12c and a removable trailer 12t. Such a truck, as shown further in FIG. 5, can transport the trailer and container to the customer's premise and then leave the trailer 12t and container 10 there, until it has been loaded. Under the principles hereof, one or several containers hereof can be left at the customer's loading dock or within the customer's premises, so that they can be loaded at the customer's convenience. When the container is loaded, the shipper returns and picks up the container. If the truck shown in FIG. 5 is used, the truck cab can be driven back by the carrier and connected with the truck trailer.

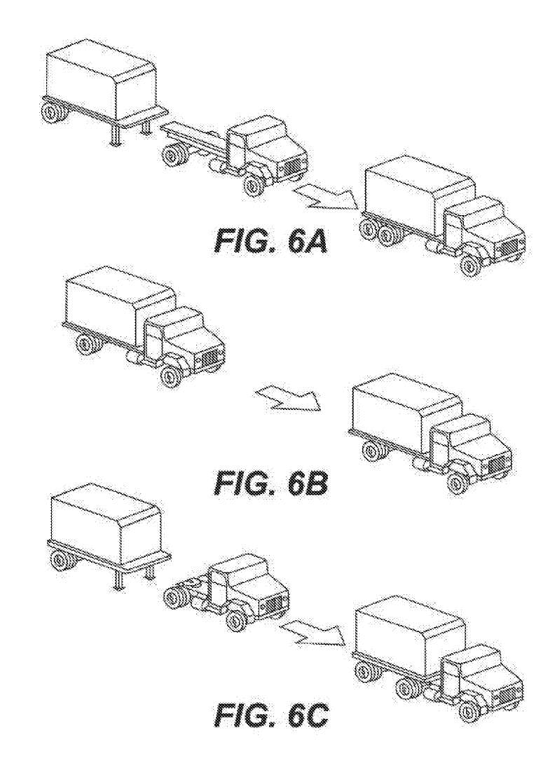

Alternative embodiments of the truck 12 are shown in FIGS. 6B and 6C. In FIG. 6B a flatbed truck is shown whereas in FIG. 6C an articulated truck is shown.

At the customer's premises, the freight of the customer (be it correspondence, paperwork, materials, goods, components, or finished products, or any other type of freight) is loaded into the container. The freight can be loose freight or freight already fixed to standard shipping pallets, such as 40-inch×48-inch wood pallets as shown in FIG. 3. The freight can be loaded by hand or by conventional loading devices, such as forklift trucks. The loading can be done by employees of the customer, or by employees or agents of the carrier, depending upon the circumstances and the desire of the customer.

Under the system and ‘method hereof, transactional data regarding the identity, nature, and destination of the freight can be placed into a portable computer device at the customer's premise. This transactional data in turn can be transferred to a central system to track the freight and generate appropriate business and customer documentation. In addition, bar code labels can be placed on the container itself, to permit easy tracking of the freight.

After the freight is loaded into the container and documented, the container is locked. Preferably, a seal is also placed on the locked doors in a manner such that the seal necessarily will be broken if the doors are opened. This aspect hereof protects the freight and permits full custodial control of the freight to be placed in the hands of a single carrier.

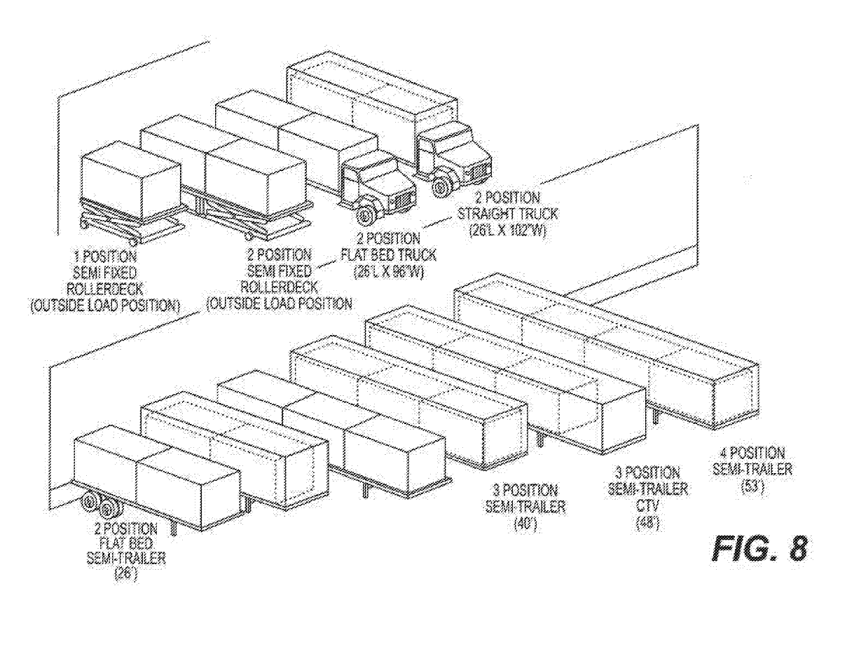

According hereto, the loaded, locked, and sealed container is then picked up by the carrier and transported to the consignee by the carrier. In some embodiments, the container is shipped to the ultimate destination, by a common carrier, to the intended consignee by land vehicles only. In that embodiment, the container can be picked up and delivered by the same truck or it can be transferred from a delivery truck (like that shown in FIGS. 4 and 5) to larger trucks (like those shown in FIG. 8) that can contain several containers.

In another embodiment, the container is picked up by the shipper's delivery truck and then transferred, directly or indirectly, to an airport, as shown in FIGS. 2 and 2A. There, one or more containers are loaded into an airplane by conventional loading devices, generally depicted in FIG. 2A. The container or containers are placed in the aircraft at selected positions and held in place by locking features, which are discussed more fully below. The airplane and container(s) are then flown to a destination airport 20. At the destination airport, the container(s) are taken off the airplane and transferred to one or more trucks. The containers are then transported by the trucks to the premise of the consignee.

In all embodiments, unless the container must be opened by customs or some other government organization, the container is delivered to the consignee in the same loaded, locked, and sealed condition that it had when it left the customer's premises. Thus, freight shipped by the preferred embodiment is kept under the custody and control of a single entity throughout the shipping process.

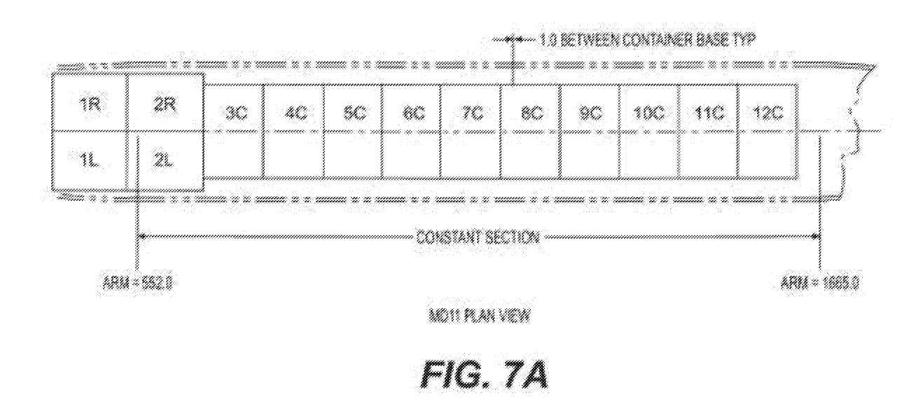

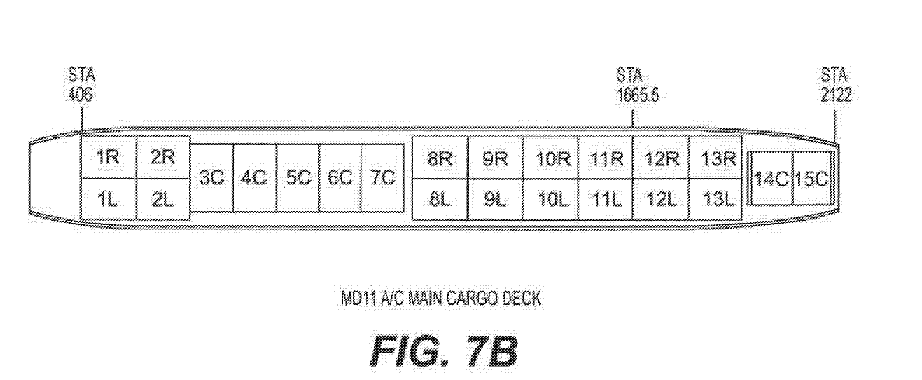

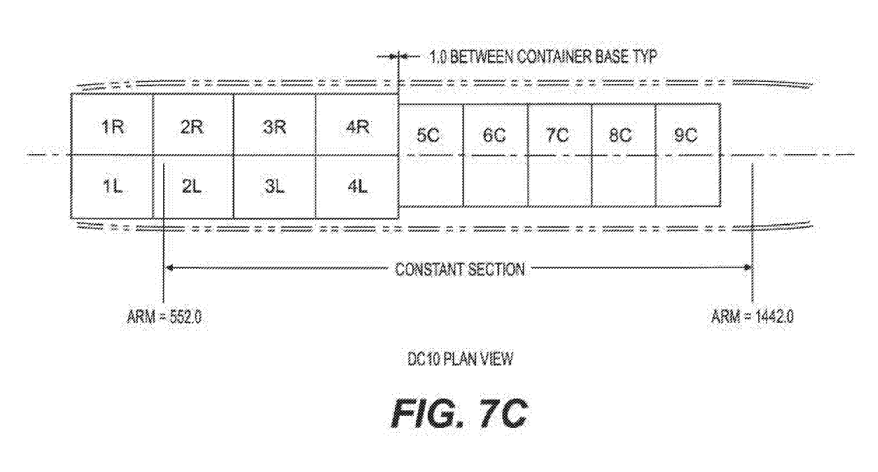

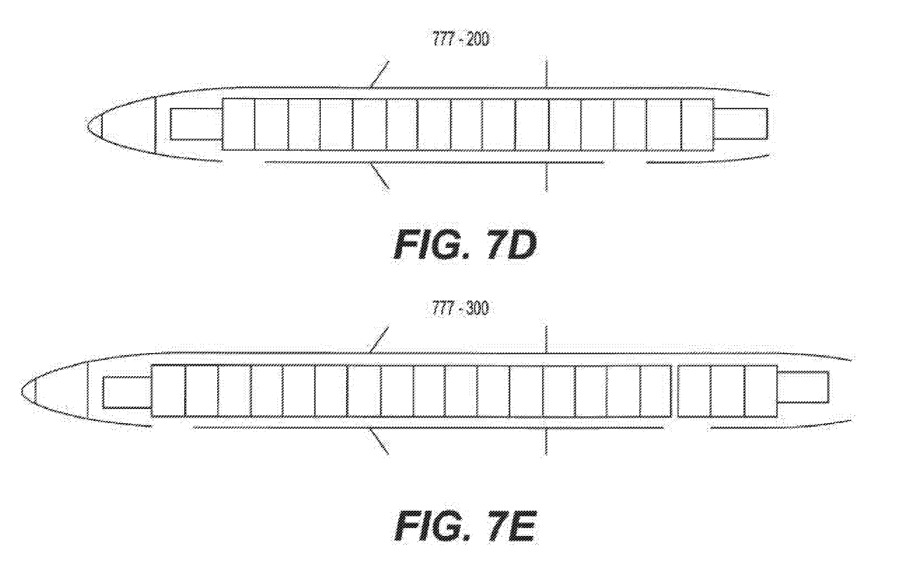

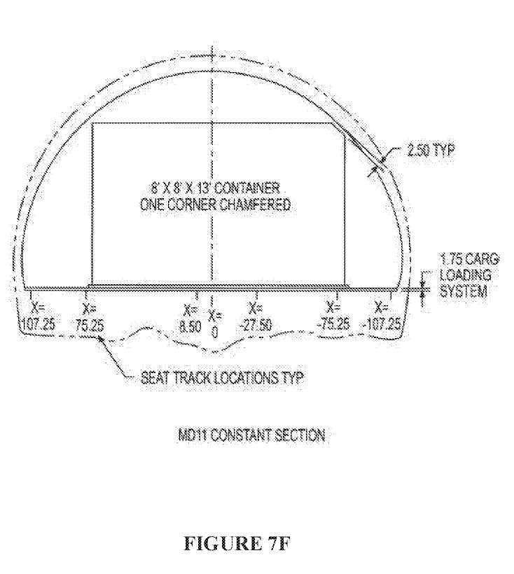

As generally illustrated in FIGS. 7 and 8, the rounded, exterior diameter adjustable shipping container hereof is sized such that it can be held and transported by a variety of different trucks of conventional size, as well as a wide variety of aircraft. The rounded, exterior diameter adjustable shipping container was designed to provide an extremely compatible and efficient container relative to a conventional freight loads and transferring freight by land, sea, and air.

The physical characteristics of the rounded, exterior diameter adjustable shipping container are designed to serve the purpose of providing a lightweight, yet safe, air container that offers enhanced customer convenience and simplified, efficient handling. The preferred outer dimensions of the container are 8 feet by 8 feet by 13 feet. With these dimensions, each container can accommodate up to 12 standard 40-inch by 48-inch pallets. Six pallets can fit on the floor; six more can be stacked on top of those. The container dimensions further permit the container to be transported by a variety of conventional land vehicles. For example, two containers will fit on a 28-foot truck or trailer, on a twin 33-foot, on a 40-foot, 45-foot, or 48-foot trailer, and four on a 53-foot. The trailers or cargo container can have any suitable dimensions or shapes, e.g., including, but not limited to single, double, triple, or more of one or more of 16, 16.5, 20, 24, 28, 28.5, 33, 40, 45, 48, 51, 53, 55, 60, 65-foot long, or 5, 5.03, 6, 6.1, 6.5, 7, 7.5, 7.82, 8, 8.5, 8.8, 9, 9.5, 10, 10.5, 11, 11.5, 12, 12.5, 13, 13.1, 13.5, 13.6, 13.7, 14, 14.5, 15, 15.5, 15.6, 16, 16.1, 16.5, 17, 17.5, 18, 18.5, 19, 19.5, 20, 20.5, 21, 21.5, 22, 23, 24, 25, 26, 27 meter long, trailers, trailer systems, cargo containers or cargo container systems, between 2 and 40 feet, or 0.5 and 13 meters in height (e.g., but not limited to 2, 4, 6, 8, 10, 12, 14, 16, 18, 20, 22, 24, 26, 28, 30, 32, 34, 36, 38 or 40 feet or 0.5, 1, 1.5, 2, 2.5, 3, 3.5, 4, 4.3, 5, 5.03, 6, 6.5, 7, 7.5, 8, 9, 10, 11, 12, or 13 meters); and, e.g., but not limited to 2 and 20 feet, or 0.5 and 7 meters in width (e.g., but not limited to 2, 4, 6, 8, 10, 12, 14, 16 feet or 0.5, 1, 1.5, 2, 2.5, 3, 3.5, 4, 4.3, 5, 5.03, 6, 6.5, or 7 meters).

The container can include a variety of different types of doors or security closures. One preferred embodiment of the container will have hinged “barn-type doors” 10d. Such an embodiment is shown in FIG. 3A. A wide variety of locking features can be used to lock the doors of the container, once it is loaded. Simple clasp and padlocks could be used, as an example. A single chamfer, designed to fit the contour of the aircraft interior, is located along the intersection of the top surface and the wall opposite the door. As shown in FIG. 7F, this chamfer allows the container to fit laterally within a variety of aircraft.

The container is constructed so that it is airworthy and weatherproof. The walls and doors of the container are constructed so that the container, when closed and locked, is substantially airtight, protecting the freight from adverse environmental conditions.

The base of the container preferably is flat and smooth on the inside and the outside. The flat surface of the container yields two benefits. First, the customer can bring a forklift or other premise device into the container to load or unload articles. Second, the container is conveyable, and more easily movable on a truck bed or the floor of an aircraft.

The container hereof preferably has a tare weight of less than 1,000 pounds, a freight volume of approximately 777 cubic feet, and a usable payload of at least approximately 10,000 pounds. The container preferably should be made of opaque materials so that the freight within the container cannot be viewed by unauthorized persons. The container can also have insulation and/or an inner liner, to add protection for the freight.

The length, width, and height of the containers are chosen to provide the widest compatibility of the container with conventional trucks and aircraft, while promoting efficiency and economy. As previously explained, the containers are sized to accept freight loaded on standard-sized pallets. The preferred 13-foot length of the container permits the container to be fit laterally (perpendicular to the longitudinal axis of the aircraft) in wide-body aircraft. The height of 8 feet also permits maximum use of space in the aircraft, as long as a chamfer is positioned on the end opposite the door. This relationship is shown in FIG. 7F. The chamfer is cut at a 45. degree angle and cuts out approximately 9.5 inches of the side and roof at the chamfer.

By example, 10 shipping containers hereof can fit on a MD-11 aircraft, as shown in FIG. 7A. The rounded, exterior diameter adjustable shipping container hereof and smaller conventional containers can also be placed on the same aircraft, as shown in FIGS. 7A and 7B (MD-11 aircraft) and FIG. 7C (DC-10). It is estimated that 17 containers could fit on a 777-200 (FIG. 7D), 21 on a 777-300 (FIG. 7E), 15 on a 747-400 full freighter (with nose door), 20 on a 747-400 passenger to freighter conversion, 25 on a 747-500 full freighter with nose door, 23 on a 747-500 passenger to freighter conversion, 29 on a 747-600 full freighter (with nose door), and 27 on a 747-600 passenger to freighter conversion.

The rounded, exterior diameter adjustable shipping container is also compatible with standard trucks for carrying freight. Again, by example only, 2 containers fit on a truck with a 28-foot bed, 3 fit on a trailer with 40, 45, and 48-foot beds, and 4 can fit on trailers with 53-foot beds, as shown in FIG. 8.

The construction of containers hereof preferably should be made of lightweight, strong, and fire-resistant materials. While low weight metals such as aluminum can be used to make the containers, other composite materials such as Lexan, carbon-fiber composites, carbon/Kevlar composites, and Kevlar/Spectra composites are preferred. Other known composites for making aircraft bodies and parts also can be used. The container's construction should result in a higher ratio of content weight to container weight. Consequently, the freight in the container will comprise a higher proportion of the gross shipping weight. This allows more freight to be shipped in each aircraft. In addition to providing lighter weight, it is preferred that the container be made of materials having a higher melting point than aluminum.

In the preferred embodiment, the beds of trucks for transporting the containers have controllable roller beds in which the retractable embedded rollers system that can be selectively raised and lowered by pneumatic or hydraulic systems, by example. When the retractable embedded rollers are raised, the containers may be easily moved in the bed of the truck with modest force. On the other hand, when the retractable embedded rollers are lowered, the friction between the container and truck will tend to minimize any unwanted movement of the container while it is being transported.

One truck design hereof includes a no articulating injector concept, which employs a cab and chassis truck and a trailer for holding the-shipping container. This embodiment is shown in FIGS. 4, 5, and 6A. The truck, which is essentially a cab 12c and a flat rail, can back under the trailer 12t and pick it up so that the wheels of the trailer become suspended. Once the trailer is hoisted, the legs of the trailer are retracted. Mechanical couplings secure the trailer to the truck. As a result, the truck can drop the container and trailer at a customer loading, dock and pick it up later, after the customer has loaded it. A preferred embodiment of this truck also will include a roller bed system with retractable embedded rollers, of the type disclosed above.

The container preferably includes a lockdown lip formed along the bottom of each side to enable the container to be fastened to the aircraft floor and truck bed. The lip extends from the container side and end walls and is approximately 0.25 to 0.75 inches thick. The lip preferably will extend between 0.75 inch to 1.5 inches outwardly from the container's end and sidewalls. Various mechanical locks in the trucks and aircraft can be used to engage the lip and hold the container in place. The present preferred embodiment of the locking features will include mechanical locks secured to the floor of the aircraft, or truck, and designed to selectively engage and lock the lip in place. Conventional locking systems can be used, as long as they are repositioned in the bed of the aircraft to match the outer dimensions of the rounded, exterior diameter adjustable shipping container hereof.

The above described containers, systems, and methods provide improved customer convenience and shipping efficiency. For example, the freight can be bar coded by the customer or the shipper while it is being loaded and unloaded. As an alternative, a bar code label can be placed on the container itself, after it is loaded. Preferably, other data regarding the freight, and its characteristics, is also documented and placed within a computer system. Preferably, the computer system is a network, which is accessible by a customer, so that the customer can utilize the shipper's tracking and processing system. This direct interface between the customer and the carrier will make it possible to expedite the preparation of business documents and the delivery of the manifest to the consignee. Coordination of arrival times will be simpler and faster. Furthermore, the system can be designed to interface with American and foreign customs departments and be capable of creating customs documents.

In a preferred embodiment, the rounded, exterior diameter adjustable shipping container, once loaded, locked and sealed, will be under the carrier's custody and control through its travel from the customer's premise to the consignee's premise. In international shipment, customer's preclearance can be available for many types of freight, so that the rounded, exterior diameter adjustable shipping container will remain locked and sealed until it reaches its final destination.

The subject matter hereof relates to a method of manufacturing plastic composite sheets containing continuous carrier fibers, which can be used in semi-structural applications. For multi-layered sheets, the continuous carrier fibers can be incorporated between the layers and for single layered sheets; the fibers are exposed on a bottom surface of the composite sheet. The continuous carrier fibers can be introduced during the consolidation process. A continuous double belt press can be used for this purpose.

The developments hereof include a reinforced thermoplastic thermoformable article, referred to herein as a “composite,” which can be thermoformed into an article having a low heat release rate and low smoke density. In an embodiment, the combustion products of the thermoformable article have low toxicity. To manufacture the composite, a porous mat is formed from a composition containing a combination of reinforcing fibers, and thermoplastic fibers. Sufficient heat is provided, for example within the drying step, to melt some of the thermoplastic fibers thus providing the mat with sufficient integrity to maintain its network structure during processing, which can include winding, shipping, unwinding and feeding into a continuous press.

In some embodiments, wherein the processing temperature in the drying step is not sufficient to begin sufficient melting of the thermoplastic fiber to produce interfiber connections, a binder is added to prevent the mat from falling apart during handling. The porous mat is then consolidated by heating, under compression, to a temperature sufficient to melt the thermoplastic fibers, and any optional binder fibers, to form a composite, followed by compression while cooling to below the Tg of the thermoplastic. Use of the combination of the fibrous components allows uniform mixing and distribution of the components in the porous mat, and can provide mats having thinner profiles. The selected polymers are also sufficiently stable to survive repeated heating to processing or forming temperature with minimal degradation.

In an embodiment, the porous compressible article is of the type described in U.S. Pat. No. 7,244,501, the disclosure of which is hereby incorporated herein by reference. Porous compressible articles of this type would be improved by eliminating the scrim layer and instead supporting the network of fibers which comprises the porous body on a plurality of spaced continuous carrier fibers which transit said network, either on the bottom surface of a layer of said network or at the interface between two layers of said network for best effect.

Long reinforcing fibers—In an embodiment, a quantity of long reinforcing fibers are provided to provide internal structure to the mat. In an embodiment, the long reinforcing fibers are from 12 mm to 75 mm in length. In an embodiment, these long reinforcing fibers are present at from 0 wt. % to 20 wt. %, replacing an equal amount of short reinforcing fibers. The long reinforcing fibers are selected from carbon fibers, aramid fibers and other materials selected to provide internal structure to the mat. In an embodiment, a composite containing the above-described long reinforcing fibers is transferred for thermoforming without a carrier scrim or spaced continuous carrier fibers.

The properties and composition of the porous mat can be varied according to need, for example, by varying the type, dimensions, and amount of reinforcing fiber. The thermoplastic, compositions and/or reinforcing fiber color can also be varied to produce a decorative effect if a clear surface film; reverse printed or not is applied (only after forming), such as a polyvinylidene fluoride (PVDF) outer, protective surface film. If the decorative film can survive the forming temperature, such as ULTEM film, the outer protective surface film can be added before forming, such as during consolidation, or a surface film (if not having specific requirements) may be formed in situ by adjusting the concentration of resin to reinforcing fibers in the outermost layer. In an embodiment, the final thermoformed product has excellent flame, smoke and toxicity (FST) properties without requiring any additional layers or additives.

The composites formed from the porous mats have a degree of loft of 3 or more, with excellent uniformity across the thickness of the mat. The composites can be thermoformed, for example, to provide an article. The composite can thus be used in the manufacture of components that meet the FAR requirements for low heat, low smoke density, and/or low levels of toxic combustion by-products. In an embodiment, the composite satisfies the following criteria: (1) a peak heat release of less than 65 kW/m², as measured by FAR 25.853 (OSU test); (2) a total heat release at 2 minutes of less than or equal to 65 kW-min./m² as measured by FAR 25.853 (OSU test); and an NBS optical smoke density of less than 200 when measured at 4 minutes, based on ASTM E-662 (FAR/JAR 25.853).

The singular forms “a,” “an,” and “the” include plural referents unless the context clearly dictates otherwise. The endpoints of all ranges reciting the same characteristic or component are independently combinable and inclusive of the recited endpoint. The term “combination” is inclusive of blends, mixtures, alloys, reaction products, and the like. The term “and a combination thereof” is inclusive of the named component and/or other components not specifically named that have essentially the same function.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The term “from more than 0 to” an amount means that the named component is present in some amount more than 0, and up to and including the higher named amount.

“Melt temperature” as used herein refers to the melt temperature of crystalline polymers, or the glass transition or softening temperature of amorphous polymers. “Processing temperature” refers to the temperature required to perform the desire process and for amorphous resins such as ULTEM resin may be more than 200 above the glass transition temperature.

Compounds are described herein using standard nomenclature. A dash (“—”) that is not between two letters or symbols is used to indicate a point of attachment for a substituent. For example, —CHO is attached through the carbon of the carbonyl (C═O) group. The term “alkyl” includes branched or straight chain, unsaturated aliphatic C1-30 hydrocarbon groups e.g., methyl, ethyl, n-propyl, i-propyl, n-butyl, s-butyl, t-butyl, n-pentyl, s-pentyl, n- and s-hexyl, n- and s-heptyl, and, n- and s-octyl. “Alkenyl” means a straight or branched chain, monovalent hydrocarbon group having at least one carbon-carbon double bond (e.g., ethenyl (—HC═CH2)). “Alkoxy” means an alkyl group that is linked via an oxygen (i.e., alkyl-O—), for example, methoxy, ethoxy, and sec-butyloxy groups.

“Alkylene” means a straight or branched chain, saturated, divalent aliphatic hydrocarbon group (e.g., methylene (—CH2-) or, propylene (—(CH2)3-)).

“Cycloalkylene” means a divalent cyclic alkylene group, —CnH2n-x, wherein x represents the number of hydrogens replaced by cyclization(s). “Cycloalkenyl” means monovalent groups having one or more rings and one or more carbon-carbon double bond in the ring, wherein all ring members are carbon (e.g., cyclopentyl and cyclohexyl).

The term “aryl” means an aromatic hydrocarbon group containing the specified number of carbon atoms, such as to phenyl, tropone, indanyl, or naphthyl.

The prefix “halo” means a group or compound including one more of a fluoro, chloro, bromo, iodo, and astatino substituent. A combination of different halo groups (e.g., bromo and fluoro) can be present. In an embodiment, only chloro groups are present.

The prefix “hetero” means that the compound or group includes at least one ring member that is a heteroatom (e.g., 1, 2, or 3 heteroatom(s)), wherein the heteroatom(s) is each independently N, O, S, or P.

“Substituted” means that the compound or group is substituted with at least one (e.g., 1, 2, 3, or 4) substituents independently selected from, a C1-9 alkoxy, a C1-9 haloalkoxy, a nitro (—NO2), a cyano (—CN), a C1-6 alkyl sulfonyl (—S(═O)2-alkyl), a C6-12 aryl sulfonyl (—S(═O)2-aryl) a thiol (—SH), a thiocyano (—SCN), a tosyl (CH3C6H4SO2-), a C3-12 cycloalkyl, a C2-12 alkenyl, a C5-12 cycloalkenyl, a C6-12 aryl, a C7-13 arylalkylene, a C4-12 heterocycloalkyl, and a C3-12 heteroaryl instead of hydrogen, provided that the substituted atom's normal valence is not exceeded.

As described above, a composition having different types of fibers is used to form a porous mat, which in turn is consolidated to provide the composite. The compositions for forming the porous mat include a plurality of reinforcing fibers and a plurality of thermoplastic fibers.

The reinforcing fibers can be metal fibers (e.g., stainless steel fibers), metallized inorganic fibers, glass fibers (e.g., lime-aluminum borosilicate glass that is soda-free (“E” glass), A, C, ECR, R, S, D, or NE glasses), graphite or graphene fibers, carbon fibers, ceramic fibers, mineral fibers, basalt fibers, polymer fibers having a melt temperature at least 150 degrees C. higher than the polyimide, or a combination thereof. The reinforcing fibers generally have a modulus higher than 10 GigaPascals (GPa). In an embodiment, the reinforcing fibers are glass fibers, cellulose nanofibers, a compatible non-glass material, or a combination thereof. As used herein, the term “compatible non-glass material” refers to a non-glass material having at least surface adhesion and wetting properties similar to those of glass, which will allow for uniform dispersion with the glass fibers.

The reinforcing fibers can be provided in the form of monofilament or multifilament fibers; non-woven fibrous reinforcements such as chopped strand mat, tissues, papers, and felts or the like. In an embodiment, the reinforcing fibers are discontinuous, in the form of single discrete fibers. Where glass fibers are used and are received in the form of chopped strand bundles, the bundles can be broken down into single fibers before making into paper. The discontinuous reinforcing fibers can be 5 to 75 millimeters (mm) in the longest dimension, 6 to 60 mm, 7 to 50 mm, or 10 to 40 mm in the longest dimension. In addition, the diameter of the discontinuous reinforcing fibers can be 3 to 125 micrometers, and in other embodiments 10 to 100 micrometers.

The continuous carrier fibers can be composed of the same range of materials, as are the reinforcing fibers, however unlike the reinforcing fibers which are discontinuous, the continuous carrier fibers are selected such that the length, type and thickness of the carrier fibers transit the fibrous mat and provide support for the fibrous mat. The continuous carrier fibers can be spaced as needed, for example, in an embodiment from 1″ to 12″, 2″ to 11″, 3″ to 10″, 4″ to 9″, 5″ to 8″, 6″ to 7″ apart, and can be oriented in various configurations, for example unidirectional oriented in the machine direction as in FIG. 1, or in the cross-machine direction, or oriented as a traversing fiber which crisscrosses the surface as shown in FIG. 2, either as one single strand, or two single strands, one from each side.

The thermoplastic fibers are selected to provide desired performance properties for the composite after melting to form a polymer matrix. In an embodiment, the thermoplastic fibers are selected to also provide interfiber bonds due to partial melting during the drying process. In another embodiment, the thermoplastic fibers do not melt sufficiently under drying conditions to provide sufficient structural integrity to the porous composite structure and a binder fiber is added to the fibers to provide inter-fiber attachments to establish structure within the porous article which allows handling of the porous article prior to consolidation.

Thermoplastic fibers, which by definition become pliable or moldable above a specific temperature, are useful in the fiber network including polyimides such as polyetherimide and polyetherimide sulfone; polycarbonates including, polycarbonate-siloxane, polyester carbonate, polyester carbonate-siloxane; polyesters including polyethylene terephthalate and polybutylene terephthalate; or if flame performance and use temperatures are of minor importance, polyolefins such as polyethylene and polypropylene; polyamides and high performance polymers, such as polybenzimidazole or liquid crystalline polymers.

Polyimide fibers contribute one type of polymer to the polymer matrix. A wide variety of polyimides can be used, depending on the availability, melt temperature, and desired characteristics of the composites. As used herein, “polyimides” is inclusive of polyetherimides and polyetherimide sulfones. In an embodiment, the polyetherimides comprise more than 1, for example, 10 to 1000 or 10 to 500 structural units, of formula (1)

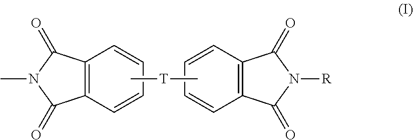

wherein each R is the same or different, and is a substituted or unsubstituted divalent organic group, such as a C6-20 aromatic hydrocarbon group or a halogenated derivative thereof, a straight or branched chain C2-20 alkylene group or a halogenated derivative thereof, a C3-8 cycloalkylene group or halogenated derivative thereof, in particular a divalent group of formula (2)

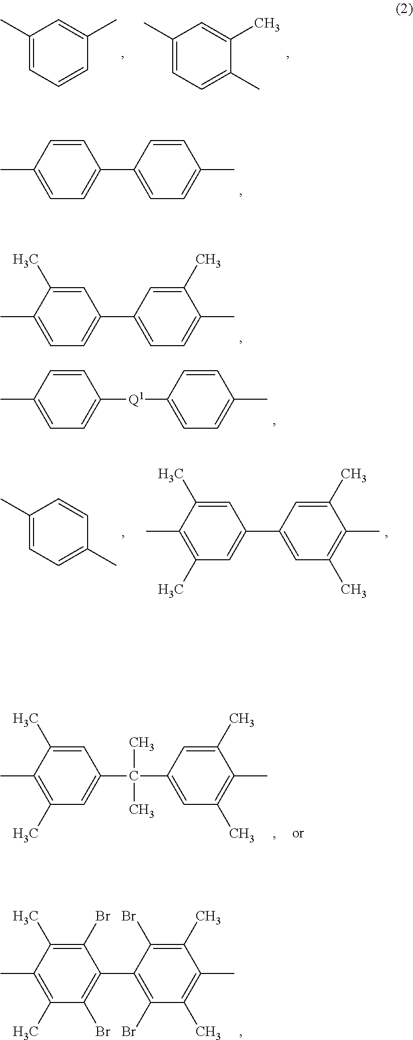

wherein Q1 is —O—, —S—, —C(O)—, —SO2-, —SO—, or —CyH2y- wherein y is an integer from 1 to 5 or a halogenated derivative thereof (which includes perfluoroalkylene groups). In an embodiment, R is an m-phenylene or p-phenylene.

Further in formula (1), T is —O— or a group of the formula —O—Z—O— wherein the divalent bonds of the —O— or the —O—Z—O— group are in the 3,3′,3,4′, 4,3′, or the 4,4′ positions. The group Z in —O—Z—O— of formula (1) is also a substituted or unsubstituted divalent organic group, and can be an aromatic C6-24 monocyclic or polycyclic moiety optionally substituted with 1 to 6 C1-8 alkyl groups, 1 to 8 halogen atoms, or a combination thereof, provided that the valence of Z is not exceeded. Exemplary groups Z include groups derived from a dihydroxy compound of formula (3):

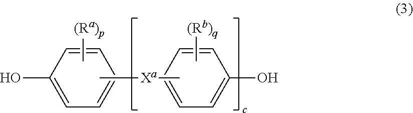

wherein Ra and Rb can be the same or different and are a halogen atom or a monovalent C1-6 alkyl group, for example, p and q are each independently integers of 0 to 4; c is 0 to 4; and Xa is a bridging group connecting the hydroxy-substituted aromatic groups, where the bridging group and the hydroxy substituent of each C6 arylene group are disposed ortho, meta, or para (in one embodiment para) to each other on the C6 arylene group. The bridging group Xa can be a single bond, —O—, —S—, —S(O)—, —S(O)2-, —C(O)—, or a C1-18 organic bridging group. The C1-18 organic bridging group can be cyclic or acyclic, aromatic or non-aromatic, and can further comprise heteroatoms such as halogens, oxygen, nitrogen, sulfur, silicon, or phosphorous. The C1-18 organic group can be disposed such that the C6 arylene groups connected thereto are each connected to a common alkylidene carbon or to different carbons of the C1-18 organic bridging group. A specific example of a group Z is a divalent group of formulas (3a)

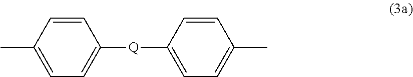

wherein Q is —O—, —S—, —C(O)—, —SO2-, —SO—, or —CyH2y- wherein y is an integer from 1 to 5 or a halogenated derivative thereof (including a perfluoroalkylene group). In a specific embodiment, Z is derived from bisphenol A wherein Q in formula (3a) is 2,2-isopropylidene.

In an embodiment in formula (1), R is m-phenylene or p-phenylene and T is —O—Z—O wherein Z is a divalent group of formula (3a). Alternatively, R is m-phenylene or p-phenylene and T is —O—Z—O wherein Z is a divalent group of formula (3a) and Q is 2,2-isopropylidene.

In some embodiments, the polyetherimide can be a copolymer, for example, a polyetherimide sulfone copolymer comprising structural units of formula (1) wherein at least 50 mole % of the R groups are of formula (2) wherein Q1 is —SO2- and the remaining R groups are independently p-phenylene or m-phenylene or a combination comprising at least one of the foregoing; and Z is 2,2-(4-phenylene)isopropylidene. Alternatively, the polyetherimide optionally comprises additional structural imide units, for example, imide units of formula (4)

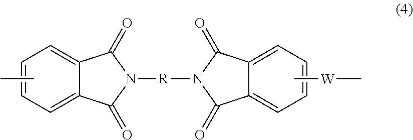

wherein R is as described in formula (1) and W is a linker of the formulas

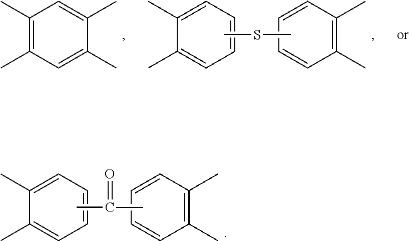

These additional structural imide units can be present in amounts from 0 to 10 mole % of the total number of units, 0 to 5 mole %, or 0 to 2 mole %. In an embodiment, no additional imide units are present in the polyetherimide.

The polyetherimide can be prepared by any of known methods, including the reaction of an aromatic bis(ether anhydride) of formula (4)

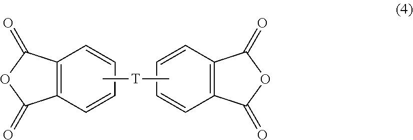

with an organic diamine of formula (5)

H₂N—R—NH₂ (5)

wherein T and R are defined as described above. Copolymers of the polyetherimides can be manufactured using a combination of an aromatic bis(ether anhydride) of formula (4) and a different bis(anhydride), for example, a bis(anhydride) wherein T does not contain an ether functionality, for example, T is a sulfone.

Illustrative examples of bis(anhydride)s include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride, as well as various combinations thereof.

Examples of organic diamines include ethylenediamine, propylenediamine, trimethylenediamine, diethylenetriamine, triethylene tetraamines, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis(4-aminophenyl) sulfone (also known as 4-[(4-aminobenzene)sulfonyl]aniline, sulfonyl dianiline, or diamino disulfone (DDS)), and bis(4-aminophenyl) ether. Combinations of these compounds can also be used. In some embodiments, the organic diamine is m-phenylenediamine, p-phenylenediamine, DDS, or a combination comprising at least one of the foregoing.

The polyetherimides can have a melt index of 0.1 to 10 grams per minute (g/min), as measured by American Society for Testing Materials (ASTM) D1238 at 340 to 370 degrees C., using a 6.7 kilogram (kg) weight. In some embodiments, the polyetherimide polymer has a weight average molecular weight (Mw) of 1,000 to 150,000 grams/mole (Dalton), as measured by gel permeation chromatography, using polystyrene standards. In some embodiments, the polyetherimide has an Mw of 10,000 to 80,000 Daltons. Such polyetherimide polymers typically have an intrinsic viscosity greater than 0.2 deciliters per gram (dl/g), or, 0.35 to 0.7 dl/g as measured in m-cresol at 25 degrees C.

The thermoplastic fibers can be 5 to 75 millimeters (mm) in the longest dimension, 6 to 60 mm, 7 to 50 mm, or 10 to 40 mm in the longest dimension. In an embodiment, the diameter of the discontinuous reinforcing fibers can be 5 to 125 micrometers, in an embodiment 10 to 100 micrometers. Thermoplastic fibers of submicron dimensions can also be used, for example, from 0.25 micrometers to 10 micrometers in diameter.

The optional polymer binder fibers contribute another polymer to the polymer matrix. The polymer binder fibers melt during formation of the porous mat, and are therefore selected to have a melt temperature lower than the melt temperature of the thermoplastic. For example, the polymer binder fibers can have a melt temperature that is at least 10 degrees C. lower than the melt temperature of the thermoplastic, at least 20 degrees C. lower, or at least 50 degrees C. lower than the melt temperature of the thermoplastic. The polymer binder fiber is further selected so as to be compatible with the thermoplastic, composition and the reinforcing fibers. The polymer binder further preferably is selected so as to not contribute significantly to the heat release, optical smoke density, and/or combustion products toxicity of the composites. Possible polymer binder fibers that can meet these criteria include thermoplastic polymers, such as silicone polymers, polyamides, polyesters, polycarbonates, polyestercarbonates, polyalphamethylstyrenes, polysulfones, and micron polyetherimide fibers (0.25 to 2 micrometer diameter fibers may be suitable as binder for polyetherimide), or a combination thereof. In an embodiment, the polymer binder is a polysiloxane-polyestercarbonate copolymer, polyester, polyester-polyetherimide blend, bicomponent fiber of any of the foregoing, or a combination thereof.

The polysiloxane-polyestercarbonate copolymer comprises siloxane units and acrylate ester units that can comprise aromatic carbonate units.

The siloxane units are present in the copolymer in polysiloxane blocks, which comprise repeating siloxane units as in formula (10):

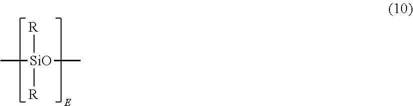

wherein each R is independently the same or different C1-13 monovalent organic group. For example, R can be a C1-C13 alkyl, C1-C13 alkoxy, C2-C13 alkenyl group, C2-C13 alkenyloxy, C3-C6 cycloalkyl, C3-C6 cycloalkoxy, C6-C14 aryl, C6-C10 aryloxy, C7-C13 arylalkyl, C7-C13 aralkoxy, C7-C13 alkylaryl, or C7-C13 alkylaryloxy. The foregoing groups can be fully or partially halogenated with fluorine, chlorine, bromine, or iodine, or a combination thereof. In an embodiment, where a transparent polysiloxane-polycarbonate is desired, R is unsubstituted by halogen. Combinations of the foregoing R groups can be used in the same copolymer.

The value of E in formula (10) can vary depending on the type and relative amount of each component in the composition, the desired properties, and like considerations. Generally, E has an average value of 5 to 50, 5 to about 40, 10 to 30. In one embodiment, the polysiloxane blocks are of formula (11) or (12)

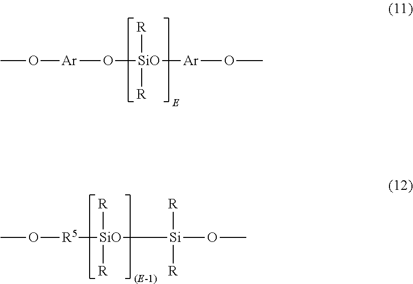

wherein E is as defined above and each R can be the same or different, and is as defined above. Ar can be the same or different, and is a substituted or unsubstituted C6-C30 arylene group, wherein the bonds are directly connected to an aromatic moiety. Ar groups in formula (11) can be derived from a C6-C30 dihydroxyarylene compound of formula (14) below, for example, 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane. Combinations comprising at least one of the foregoing compounds can also be used. Each R5 is independently a divalent C1-C30 organic group, for example, a divalent C2-C8 aliphatic group.

In a specific embodiment, the polysiloxane blocks are of formula (13):

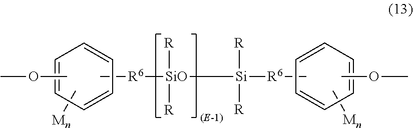

wherein R and E are as defined above; R6 is a divalent C2-C8 aliphatic group; each M can be the same or different, and can be a halogen, cyano, nitro, C1-C8 alkylthio, C1-C8 alkyl, C1-C8 alkoxy, C2-C8 alkenyl, C2-C8 alkenyloxy group, C3-C8 cycloalkyl, C3-C8 cycloalkoxy, C6-C10 aryl, C6-C10 aryloxy, C7-C12 aralkyl, C7-C12 aralkoxy, C7-C12 alkylaryl, or C7-C12 alkylaryloxy, wherein each n is independently 0, 1, 2, 3, or 4. In an embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R2 is a dimethylene, trimethylene or tetramethylene group; and R is a C1-8 alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is one, R2 is a divalent C1-C3 aliphatic group, and R is methyl.

The polysiloxane-polyestercarbonate copolymer further comprises polyester blocks, in particular polyarylate ester blocks that optionally comprise carbonate units. The arylate ester units of the polyarylate ester blocks can be derived from the reaction product of one equivalent of an isophthalic acid derivative and/or terephthalic acid derivative with an aromatic dihydroxy compound of the formula HO—R1-OH, in particular of formula (14) or (15).

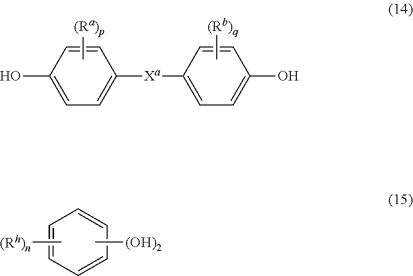

In formula (14), Ra and Rb are each independently a halogen atom or a monovalent hydrocarbon group; p and q are each independently integers of 0 to 4; and Xa is a bridging group connecting the two hydroxy-substituted aromatic groups, where the bridging group and the hydroxy substituent of each C6 arylene group are disposed ortho, meta, or para (in an embodiment para) to each other on the C6 arylene group. In an embodiment, the bridging group Xa is —C(Rc)(Rd)- or —C(═Re) (wherein Rc and Rd each independently is a hydrogen atom or a monovalent linear or cyclic hydrocarbon group and Re is a divalent hydrocarbon group), a single bond, —O—, —S—, —S(O)—, —S(O)2-, —C(O)—, or a C1-18 organic group. The C1-18 organic bridging group can be cyclic or acyclic, aromatic or non-aromatic, and can further comprise heteroatoms such as halogens, oxygen, nitrogen, sulfur, silicon, or phosphorous. The C1-18 organic group can be disposed such that the C6 arylene groups connected thereto are each connected to a common alkylidene carbon or to different carbons of the C1-18 organic bridging group. In one embodiment, p and q is each 1, and Ra and Rb are each a C1-3 alkyl group, for example methyl, disposed meta to the hydroxy group on each arylene group. In another embodiment, Xa is a C1-18 alkylene group, a C3-18 cycloalkylene group, a fused C6-18 cycloalkylene group, or a group of the formula —B1-W—B2- wherein B1 and B2 are the same or different C1-6 alkylene group and W is a C3-12 cycloalkylidene group or a C6-16 arylene group.

In formula (15), wherein each Rh is independently a halogen atom, a C1-10 hydrocarbyl such as a C1-10 alkyl group, a halogen-substituted C1-10 alkyl group, a C6-10 aryl group, or a halogen-substituted C6-10 aryl group, and n is 0 to 4. The halogen is usually bromine.

Illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1, 1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (14) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Specific examples of compounds of formula (15) include 5-methyl resorcinol, hydroquinone, and 2-methyl hydroquinone. Combinations comprising at least one of the foregoing dihydroxy compounds can also be used.

The polyarylate ester blocks can comprise 100 mole % (mol %) of arylate ester units as illustrated in formula (16):

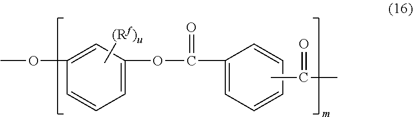

wherein Rf and u are previously defined for formula (15), and m is greater than or equal to 4. In embodiments, m is 4 to 50, 5 to 30, 5 to 25, or 10 to 20. Also in an embodiment, m is less than or equal to 100, less than or equal to 90, less than or equal to 70, or less than or equal to 50. It will be understood that the low and high endpoint values for m are independently combinable. In another embodiment, the molar ratio of isophthalate to terephthalate can be about 0.25:1 to about 4.0:1.

Exemplary arylate ester units are aromatic polyester units such as isophthalate-terephthalate-resorcinol ester units, isophthalate-terephthalate-bisphenol A ester units, or a combination thereof. Specific arylate ester units include poly(isophthalate-terephthalate-resorcinol) esters, poly(isophthalate-terephthalate-bisphenol-A) esters, poly[(isophthalate-terephthalate-resorcinol) ester-co-(isophthalate-terephthalate-bisphenol-A)] ester, or a combination thereof. In an embodiment, a useful arylate ester unit is a poly(isophthalate-terephthalate-resorcinol) ester. In an embodiment, the arylate ester unit comprises isophthalate-terephthalate-resorcinol ester units in an amount greater than or equal to 95 mol %, greater than or equal to 99 mol %, or greater than or equal to 99.5 mol % based on the total number of moles of ester units in the polyarylate unit. In another embodiment, the arylate ester units are not substituted with non-aromatic hydrocarbon-containing substituents such as, for example, alkyl, alkoxy, or alkylene substituents.

Alternatively, the polyarylate ester blocks are polyestercarbonate blocks that comprise arylate ester units and carbonate units shown in formula (17):

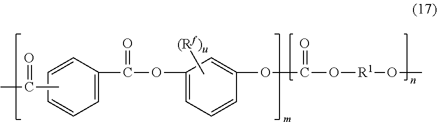

wherein Rf, u, and m are as defined in formula (16), each R1 is independently an aromatic dihydroxy compound of the formula HO—R1-OH, in particular of formula (14) or (15), and n is greater than or equal to one. In embodiments, m is from 3 to 50, from 5 to 25, from 5 to 20; and n is less than or equal to 50, less than or equal to 25, less than or equal to 20. It will be understood that the endpoint values for n are independently combinable. In an embodiment, m is from 5 to 75, from 5 to 30, from 10 to 25, and n is less than 20. In a further embodiment, m is 5 to 75, and n is 3 to 50; or m is 10 to 25, and n is 5 to 20. In an embodiment, the molar ratio of the isophthalate-terephthalate ester units to the carbonate units in the polyestercarbonate block can be 100:0 to 50:50, 95:5 to 60:40, or 90:10 to 70:30.

In another embodiment, the polyestercarbonate unit comprises bisphenol carbonate units of formula (18) (derived from bisphenols of formula (14) and/or resorcinol carbonate units of formula (19) (derived from resorcinols of formula (15):

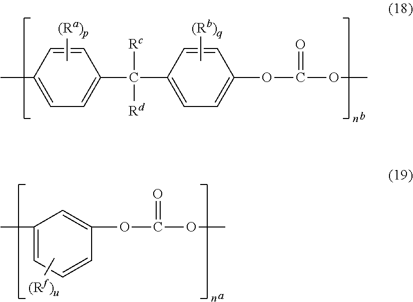

wherein Ra and Rb are each individually C1-8 alkyl, Rc and Rd are individually C1-8 alkyl or C1-8 cycloalkylene, p and q are 0 to 4, and nb is greater than or equal to one; and wherein Rf and u are as described above, and na is greater than or equal to 1. The polyestercarbonate units comprise a molar ratio of bisphenol carbonate units of formula (18) to resorcinol carbonate units of formula (19) of 0:100 to 99:1, or 20:80 to 80:20. In another embodiment, the polyestercarbonate blocks are derived from resorcinol (i.e., 1,3-dihydroxybenzene), or a combination comprising resorcinol and bisphenol-A, for example, the polyestercarbonate block is a poly(isophthalate-terephthalate-resorcinol ester)-co-(resorcinol carbonate)-co-(bisphenol-A carbonate).

In an embodiment, the polyestercarbonate blocks of the polysiloxane-polyestercarbonate copolymer consist of 50 to 100 mol % of arylate ester units, 58 to 90 mol % arylate ester units; 0 to 50 mol % aromatic carbonate units (e.g., resorcinol carbonate units, bisphenol carbonate units and other carbonate units such as aliphatic carbonate units); 0 to 30 mol % resorcinol carbonate units, 5 to 20 mol % resorcinol carbonate units; and 0 to 35 mol % bisphenol carbonate units, or 5 to 35 mol % bisphenol carbonate units.

The polyestercarbonate unit can have an Mw of 2,000 to 100,000 g./mol, 3,000 to 75,000 g./mol, 4,000 to 50,000 g./mol, 5,000 to 35,000 g./mol, or 17,000 to 30,000 g./mol. Molecular weight determinations are performed using GPC using a crosslinked styrene-divinyl benzene column, at a sample concentration of 1 milligram per milliliter, and as calibrated with polycarbonate standards. Samples are eluted at a flow rate of about 1.0 ml/min with methylene chloride as the eluent.

The polysiloxane-polyestercarbonate copolymers can be manufactured by known methods, for example, reaction of the corresponding dihydroxy compounds of formulas (11), (12), and (13) with dicarboxylic acid derivatives and dihydroxy compounds of formulas (14) and (15) by different methods such as solution polymerization, interfacial polymerization, and melt polymerization. For example, the polysiloxane-polyestercarbonate copolymer can be prepared by interfacial polymerization, such as by the reaction of a diacid derivative, a difunctional polysiloxane polymer, a dihydroxy aromatic compound, and where desired, a carbonyl source, in a biphasic medium comprising an immiscible organic phase and aqueous phase. The order and timing of addition of these components to the polymerization reaction can be varied to provide a polysiloxane-polyestercarbonate copolymer having different distributions of the polysiloxane blocks in the polymer backbone. The polysiloxane can be distributed within the ester units in the polyester units, the carbonate units in the polycarbonate units, or both. Proportions, types, and amounts of the reaction ingredients can be selected by a skilled artisan to provide polysiloxane-polyestercarbonate copolymers having specific desirable physical properties for example, heat release rate, low smoke, low toxicity, haze, transparency, molecular weight, polydispersity, glass transition temperature, impact properties, ductility, melt flow rate, and weatherability.

In an embodiment, the polysiloxane-polyestercarbonate copolymer can comprise siloxane units in an amount of 0.5 to 20 mol %, 1 to 10 mol % siloxane units, based on the combined mole percentages of siloxane units, arylate ester units, and optional carbonate units, and provided that siloxane units are provided by polysiloxane units covalently bonded in the polymer backbone of the polysiloxane-polyestercarbonate copolymer composition. The polysiloxane-polyestercarbonate copolymer comprises siloxane units in an amount of 0.2 to 10 weight percent (wt. %), 0.2 to 6 wt. %, 0.2 to 5 wt. %, or 0.25 to 2 wt. %, based on the total weight of the polysiloxane-polyestercarbonate copolymer, with the proviso that the siloxane units are provided by polysiloxane units covalently bonded in the polymer backbone of the polysiloxane-polyestercarbonate copolymer. In another embodiment, the copolymer further comprises 0.2 to 10 wt. % siloxane units, 50 to 99.8 wt. % ester units, and 0 or more than 0 to 49.85 wt. % carbonate units; or 0.3 to 3 wt. % polysiloxane units, 60 to 96.7 wt. % ester units, and 3 to 40 wt. % carbonate units, wherein the combined weight percentages of the polysiloxane units, ester units, and carbonate units is 100 wt. % of the total weight of the polysiloxane-polyestercarbonate copolymer composition.

The polysiloxane-polyestercarbonate copolymers can have an intrinsic viscosity, as determined in chloroform at 25 degrees C., of 0.3 to 1.5 deciliters per gram (dl./g.), or 0.45 to 1.0 dl./g. The polysiloxane-polyestercarbonate copolymers can have a weight average molecular weight (Mw) of 10,000 to 100,000 g./mol, as measured by gel permeation chromatography (GPC) using a crosslinked styrene-divinyl benzene column, at a sample concentration of 1 milligram per milliliter, and as calibrated with polycarbonate standards.

In an embodiment, the polysiloxane-polyestercarbonate copolymer has flow properties described by the melt volume flow rate (MVR), which measures the rate of extrusion of a thermoplastic polymer through an orifice at a prescribed temperature and load. Polysiloxane-polyestercarbonate copolymers suitable for use can have an MVR, measured at 300 degrees C. under a load of 1.2 kg according to ASTM D1238-04, of 0.5 to 80 cubic centimeters per 10 minutes (cc./10 min.). In a specific embodiment, an exemplary polycarbonate has an MVR measured at 300 degrees C. under a load of 1.2 kg according to ASTM D1238-04, of 0.5 to 100 cc./10 min., 1 to 75 cc./10 min., or 1 to 50 cc./10 min. Combinations of polycarbonates of different flow properties can be used to achieve the overall desired flow property. The polysiloxane-polyestercarbonate copolymer can have a Tg of less than or equal to 165 degrees C., less than or equal to 160 degrees C., or less than or equal to 155 degrees C. The polysiloxane-polyestercarbonate copolymer can have a Tg for the polycarbonate unit of greater than or equal to 115 degrees C., or greater than or equal to 120 degrees C. In an embodiment, the polysiloxane-polyestercarbonate copolymer has a melt volume rate (MVR) of 1 to 30 cc./10 min., or 1 to 20 cc./10 min., when measured at 300 degrees C. under a load of 1.2 kg. according to ASTM D1238-04, and a Tg of 120 to 160 degrees C., 125 to 155 degrees C., or 130 to 150 degrees C.

Still further in an embodiment, the polysiloxane-polyestercarbonate copolymer composition has a 2 minute integrated heat release rate of less than or equal to 65 kilowatt-minutes per square meter (kW-min./m.2) and a peak heat release rate of less than 65 kilowatts per square meter (kW./m.2) as measured using the method of FAR F25.4, in accordance with Federal Aviation Regulation FAR 25.853 (d). Polysiloxane-polyestercarbonate copolymers are commercially available from SABIC Innovative Plastics, Pittsfield, Mass.

Prior to being formed into fibers, the selected polymers can be formulated with various additives ordinarily incorporated into polymer compositions of this type, with the proviso that the additives are selected so as to not significantly adversely affect the desired properties of the fibers or fiber spinning process. Exemplary additives include fillers, catalysts (for example, to facilitate reaction between an impact modifier and the polyester), antioxidants, thermal stabilizers, light stabilizers, ultraviolet light (UV) absorbing additives, quenchers, plasticizers, lubricants, mold release agents, antistatic agents, visual effect additives such as dyes, pigments, and light effect additives, flame resistances, anti-drip agents, and radiation stabilizers. Combinations of additives can be used. The foregoing additives (except any fillers) are generally present in an amount from 0.005 to 10 wt. %, or 0.01 to 5 wt. %, based on the total weight of the composition.

In a specific embodiment, certain flame retarding agents are excluded from the compositions, in particular, flame retardants that include phosphorus, bromine, and/or chlorine. Non-brominated and non-chlorinated phosphorus-containing flame retardants can be preferred in certain applications for regulatory reasons, for example, organic phosphates. In another specific embodiment, inorganic flame retardants are excluded from the compositions, for example, salts of C1-16 alkyl sulfonate salts such as potassium perfluorobutane sulfonate (Rimar salt), potassium perfluorooctane sulfonate, tetraethyl ammonium perfluorohexane sulfonate, and potassium diphenylsulfone sulfonate, and the like; salts formed by reacting for example, an alkali metal or alkaline earth metal (for example, lithium, sodium, potassium, magnesium, calcium, and barium salts) and an inorganic acid complex salt, for example, an oxo-anion, such as alkali metal and alkaline-earth metal salts of carbonic acid, such as Na2CO3, K2CO3, MgCO3, CaCO3, and BaCO3 or fluoro-anion complexes such as Li3AlF6, BaSiF6, KBF4, K3AlF6, KAlF4, K2SiF6, and/or Na3AlF6 or the like.

The thermoplastic, compositions, cellulose nanofiber composition and optional polymer binders may be formed into fibers by known processes. These fibers, together with the reinforcing fibers are combined to provide a composition for the production of a porous article such as a mat. Consolidation of the porous article is conducted under heat and pressure, and cooled under heat and pressure, to provide a composite that can then be thermoformed to provide articles useful in the manufacture of interior aircraft panels, for example.

In particular, a composition for the manufacture of a porous, compressible article such as a mat includes a combination of a plurality of reinforcing fibers; a plurality of thermoplastic fibers; and optionally a plurality of polymeric binder fibers wherein the polymeric binder fibers have a melting point lower than the thermoplastic fibers. When the binder fiber is present, the composition is thermally treated to selectively melt and flow the polymer binder fibers such that the polymer binder adheres adjoining fibers together upon cooling, to produce a mat containing a network of discontinuous, randomly oriented reinforcing fibers and thermoplastic fibers bonded together using melted fibers of the polymer binder. The porous mat is then thermally treated under pressure to melt and flow the thermoplastic fibers such that the thermoplastic composition adheres adjoining fibers together upon cooling. In this way, an interconnected network of reinforcing fibers and a polymer matrix (dual polymer matrix when optional polymer binder is included) is formed. The network so prepared has high loft and uniformity of loft across the structure.

A method for forming a porous mat accordingly includes forming a layer comprising a suspension of the combination of a plurality of reinforcing fibers; a plurality of thermoplastic fibers; and optionally a plurality of polymeric binder fibers in a liquid, for example, an aqueous fluid; at least partially removing the liquid from the suspension to form a web; heating the web under conditions sufficient to remove any remaining aqueous fluid from the web and to melt the polymeric binder fibers if present, or if no binder fiber is present at least some of the thermoplastic fiber is melted to act as the binder (optionally, thermoplastic micro fiber may also be usable as binder fiber or matrix resin fiber); and cooling the heated web to form the porous mat, wherein the porous mat comprises a network of the reinforcing fibers and the thermoplastic fibers, optionally in a matrix of the polymeric binder.

The reinforcing fibers, thermoplastic fibers, and optional polymeric binder fibers are combined in a liquid medium to form a suspension, wherein the fibers are substantially uniformly suspended and distributed throughout the medium. In one embodiment, the combining is performed by introducing the fibers into an aqueous medium to provide a suspension, which can be a slurry, dispersion, or emulsion. The combining is performed so as to render the fibers substantially evenly dispersed in the aqueous medium, and can use agitation to establish and maintain the dispersion of these components. The suspension can further comprise additives such as dispersants, buffers, anti-coagulants, surfactants, and the like, and combinations thereof, to adjust or improve the flow, dispersion, adhesion, or other properties of the suspension. The suspension can be a foamed suspension comprising the fibers, water, and a surfactant. The percentage by weight of solids of the suspension can be from 0.1 to 99 wt. %, 2 to 50 wt. %, or 0.05 to 10 wt. %. Additives can be present in an amount effective for imparting desired properties of foaming, suspension, flow, and the like.

The suspension can be prepared in batch mode, and used directly or stored for later use, or alternatively be formed in a continuous manufacturing process wherein the components are each combined to form the suspension at a time just prior to the use of the suspension.

To form a porous article such as a mat, the suspension is applied as a slurry to a porous surface, for example, a wire mesh, and the liquid and suspended components too small to remain on the porous surface are removed through the porous surface by gravity or use of vacuum, to leave a layer comprising a dispersion of fibers on the porous surface. In an exemplary embodiment, the porous surface is a conveyor belt having pores, and of dimensions suitable to provide, after application of the dispersed medium and removal of liquid, a fibrous mat having a width of 2 meters and of continuous length. The dispersed medium can be contacted to the porous surface by distribution through a head box, which provides for application of a coating of the dispersed medium having a substantially uniform width and thickness over the porous surface. Typically, vacuum is applied to the porous surface on a side opposite the side to which the dispersed medium is applied, to draw the residual liquid and/or small particles through the porous surface, thereby providing a web in substantially dried form. In an embodiment, the layer is dried to remove moisture by passing heated air through the layer mat preferably in a downward draft oven to keep from dispersing the fibers.

Upon removal of the excess dispersed medium and/or moisture, the non-bonded, web comprising the fibers is thermally treated to form a porous article, for example, a mat. In an embodiment, the web is heated by passing heated air through the web in a forced-hot-air-oven. In this way, the web can be dried using air heated at a temperature of greater than or equal to, e.g., 100 degrees C. under a flow of air.

The heating temperature to form the porous mat is selected based upon the properties of the polymers employed in a given embodiment. In embodiments that employ the optional binder, the heating temperature is selected to substantially soften and melt the polymer binder, but not the thermoplastic fiber, for example, at a temperature from 130 to 170 degrees C. In an embodiment, the heating comprises heating in an oven at a temperature from 130 to 150 degrees C., then infrared heating at a temperature from 150 to 200 degrees C. During heating of the web, the polymer binder melts and flows to form a common contact (e.g., a bridge) between two or more of the reinforcing and thermoplastic fibers, and forms an adhesive bond with the fibers upon cooling to a non-flowing state, thereby forming the porous article.

In embodiments that do not employ the optional binder, the heating temperature to form the porous mat is selected to substantially soften and melt the thermoplastic fiber matrix and form attachment points between fibers, for example, at a temperature from 230 to 270 degrees C. In an embodiment, the heating comprises drying in an oven at a temperature from 130 to 150 degrees C., then infrared heating at a temperature from 250 to 270 degrees C. for a short time for polyetherimide fiber matrix, or at a lower temperature for polymer matrices having a lower softening temperature. A roller nip can also be used to improve adhesion of the softened fibers. During heating of the web thermoplastic, some of the fibers soften and adhere to other fibers to form a connection at points of contact (e.g., a bridge) between two or more of the reinforcing and thermoplastic fibers, and forming an adhesive bond with the fibers upon cooling to a non-flowing state, thereby forming the porous article.

The porous article comprises a network of the plurality of reinforcing fibers and the plurality of thermoplastic fibers. The porous article can have an areal weight of from 50 to 500 g./m.2. Alternatively, or in addition, the porous article has a porosity of greater than about 0%, more particularly about 5% to about 95%, and still more particularly about 20% to about 80% by volume.

A composite is formed from the porous article, by heating and compressing at least one of the porous articles under conditions sufficient to melt the thermoplastic fibers and consolidate the network; and cooling the heated, compressed article under pressure to form the composite comprising a network comprising a plurality of reinforcing fibers; and a matrix comprising melted and cooled thermoplastic fibers, and melted and cooled polymeric binder fibers, wherein the polymeric binder has a melt temperature lower than the thermoplastic. The matrix and any binder fiber are substantially fully melted and little evidence of their fibrous nature typically remains once compressed and cooled.

During thermoforming, heating is at a temperature effective to soften the polyimide, for example, a temperature of 300 to 385 degrees C., or 330 to 365 degrees C., and a pressure of 1 bar to 15 bar, or 3 bar to 8 bar. During heating of the porous article, the polyimide softens and may flow to form a common contact (e.g., a bridge) between two or more of the reinforcing fibers, and forms an adhesive bond with the fibers upon cooling to a non-flowing state, thereby forming the composite. Heat-treating and compression can be by a variety of methods, for example, using double belt laminators, indexing presses, multiple daylight presses, autoclaves, and other such devices used for lamination and consolidation of sheets so that the thermoplastic can flow and wet out the fibers. The gap between the consolidating elements in the consolidation devices may be set to a dimension less than that of the unconsolidated web and greater than that of the web if it were to be fully consolidated, thus allowing the web to expand and remain substantially permeable after passing through the rollers. In one embodiment, the gap is set to a dimension about 5% to about 10% greater than that of the web if it were to be nearly fully consolidated (full consolidation is likely to break a large percentage of the reinforcing fibers thus reducing both the lofting and the mechanical properties of the sheet especially after forming). It may also be set to provide a nearly fully consolidated web that is later re-lofted and molded to form particular articles or materials. A fully consolidated web means a web that is fully compressed and substantially void free, but may have poor mechanical and lofting performance. A fully consolidated web would have less than about 5% void content and have negligible open cell structure.

In an embodiment, the article is a mat. Two or more mats can be stacked and heated treated under compression, for example 2 to 12 mats, 3 to 11 mats, 4 to 9 mats, 5 to 8 mats, or 6 to 7 mats.

In an advantageous feature, the composite has a minimum degree of loft of greater than or equal to three. In another advantageous feature, the loft of the composite is within one sigma, over the entirety of the composite. Alternatively, or in addition, the loft of the composite is within 30%, over the entirety of the composite. Loft can be understood as the expansion that the composite sheet undergoes as it is reheated without pressure to the processing temperature of the thermoplastic, compared to the thickness of the fully consolidated sheet. It indicates primarily the degree of stress in the reinforcing fiberglass, the viscosity of the matrix resin as well as fiber attrition that occurred during consolidation, which provides an indication of mechanical strength and formability. Manufacturing cycle time of the product is shortened considerably, from several hours down to minutes.

The porosity of the composite is generally less than about 10 volume % or a minimum of about 5% or sufficient to permit drawing a vacuum through the composite to form and attach a decorative surface film.

In a specific embodiment, a composite includes a network comprising a plurality of reinforcing fibers selected from metal fibers, metallized inorganic fibers, glass fibers, cellulose nanofibers, graphite or graphene fibers, carbon fibers, ceramic fibers, mineral fibers, basalt fibers, and polymer fibers having a melt temperature at least 150 degrees C. higher than the thermoplastic, and combinations thereof; and a matrix comprising: (a) melted and cooled polyimide fibers and (b) melted and cooled optional polymeric binder fibers, wherein the polymeric binder has a melt temperature lower than the thermoplastic, and wherein the composite has a minimum degree of loft of greater than or equal to three, and the loft of the composite is within 30% over the entirety of the composite. In an embodiment, the composite does not include a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.

Layers of thermoplastic material, woven and non-woven fabrics and the like, can optionally be laminated to the composite to form a structure having two or more layers. Lamination is effected by feeding one or more optional top layers of material, and/or one or more bottom layers of material, into a nip roller simultaneously with the composite. The nip roller temperature may be controlled to about 200 degrees C., and can provide temperature control for the heated structure during application of pressure, and thus during formation of the composite. The roller pressure for compressing and/or compacting the fibrous mat and/or additional layers can be adjusted to maximize the final properties of the structure.

If not consolidated directly after preparation, the composite or layered structure prepared therefrom can be folded (fastooned) (for example, up to 2 layers), or rolled.

Structures containing more layers can be rolled onto very large diameter rollers, about as many feet in diameter as the number of layers thick. Accordingly, structures over 8 layers thick would require very large equipment to roll them. Consolidated product of 1 to at least 4 layers can be rolled onto cores of 6″-12″ diameter and be shipped to the customer, who would be able to cut the sheet lengths chosen for optimal yield even being able to remove a defective section without losing a whole sheet. The composite or layered structure can also be sheared into sheets. The cut composite and/or the layered structure can be molded and expanded to form an article of a desired shape, for use in manufacture of further articles. The intermediate rolled, folded, or sheeted composite or layered structure can further be molded into an article of a suitable shape, dimension, and structure for use in further manufacturing processes to produce further articles.

While any suitable method of forming an article using the composite is contemplated, in a particular embodiment, the composite is advantageously formed into an article by thermoforming, which can reduce the overall cost in manufacturing the article. It is generally noted that the term “thermoforming” is used to describe a method that can comprise the sequential or simultaneous heating and forming of a material onto a mold at below the Tg of the resin, wherein the material is originally in the form of a film, sheet, layer, or the like, and can then be formed into a desired shape. Once the desired shape has been obtained, the formed article (e.g., a component of an aircraft interior such as a panel) is cooled below its melt or glass transition temperature. Exemplary thermoforming methods can include, but are not limited to, mechanical forming (e.g., matched tool forming), membrane assisted pressure/vacuum forming, membrane assisted pressure/vacuum forming with a plug assist, and the like. It can be noted the greater the draw ratio, the greater the degree of lofting needs to be, to be able to form a part of uniform thickness. Variable thickness can actually be used as a design feature by increasing the thickness for extra stiffness or increasing the compression for extra strength as where a fastener is required. Such a shape also provides aerodynamic and friction and wind reducing shape that increases the efficiency of the trailer when carried by a truck or cab or other pulling vehicle, such that the aerodynamic or curved shape can increase one or more of fuel efficiency, decrease rolling friction, increase speed with less torque, improved handling and stability, and/or other improvement in trailer pulling efficiency.

In an embodiment, the composites and articles formed from the composites meet certain flame retardant properties presently required by the airline transportation industry. In an embodiment, the composite and articles comprising the composite (including a thermoformed sheet and an interior airplane component, and other articles disclosed herein) can exhibit at least one of the following desirable properties: (1) a peak heat release of less than 65 kW./m.2, as measured by FAR 25.853 (OSU test); (2) a total heat release at 2 minutes of less than or equal to 65 kW-min./m.2 as measured by FAR 25.853 (OSU test), (3) an NBS (National Board of Standards) optical smoke density of less than 200 when measured at 4 minutes, based on ASTM E-662 (FAR/JAR 25.853). In an embodiment, all three of the foregoing properties are met.

In a specific embodiment, an article includes a thermoformed composite, wherein the composite includes a network comprising a plurality of reinforcing fibers selected from metal fibers, metallized inorganic fibers, metallized synthetic fibers, glass fibers, cellulose nanofibers, graphite or graphene fibers, carbon fibers, ceramic fibers, mineral fibers, basalt fibers, polymer fibers having a melt temperature at least 150 degrees C. higher than the thermoplastic, and combinations thereof; and a matrix comprising: (a) melted and cooled polyimide fibers and (b) melted and cooled polymeric binder fibers, wherein the polymeric binder has a melt temperature lower than the thermoplastic, and wherein the composite has a minimum degree of loft of greater than or equal to three and the loft of the composite is within 30% over the entirety of the composite.

In another embodiment, the combustion products can be nontoxic, that is, the composite and articles formed therefrom have toxic emissions levels to pass the requirements for toxicity described in Airbus Test Specifications ATS 1000.0001 and ABD 0031, and Boeing Standard Specification BSS 7239. In an embodiment, the composites can have a toxic gases release of less than or equal to 100 ppm based on Draeger Tube Toxicity test (Airbus ABD0031, Boeing BSS 7239). In another embodiment, the composites can have, as determined using a Draeger tube, for flaming conditions, less than 150 parts per million (ppm) hydrogen cyanide (HCN), less than 3,500 ppm carbon monoxide (CO), less than 100 ppm nitrogen oxides (NO and NO2), less than 100 ppm sulfur dioxide (SO2), and less than 150 ppm hydrogen chloride (HCl); and for non-flaming conditions, less than 150 parts per million (ppm) hydrogen cyanide (HCN), less than 3,500 ppm carbon monoxide (CO), less than 100 ppm nitrogen oxides (NO and NO2), less than 100 ppm sulfur dioxide (SO2), and less than 150 ppm hydrogen chloride (HCl).

Skilled artisans will also appreciate that common curing and surface modification processes including but not limited to heat-setting, texturing, embossing, corona treatment, flame treatment, plasma treatment, and vacuum deposition can further be applied to the above articles to alter surface appearances and impart additional functionalities to the articles. Additional fabrication operations can be performed on articles, such as, but not limited to molding, in-mold decoration, baking in a paint oven, lamination, hard coating and molded on attachment features.

Articles prepared from these composites include those used to fabricate interior panels for aircraft, trains, automobiles, passenger ships, and the like, and are useful where good thermal and sound insulation are desired. Articles include aircraft parts including oxygen mask compartment covers; and thermoformed and non-thermoformed articles prepared from sheets of the composites such as light fixtures; lighting appliances; light covers, cladding or seating for public transportation; cladding or seating for trains, subways, or buses; meter housings; and like applications. Other specific applications include window shades, air ducts, compartments and compartment doors for storage and luggage, tray tables, oxygen mask compartment parts, air ducts, window trim, and other parts such as panels used in the interior of aircraft, trains or ships.

The present subject matter is further illustrated by the following non-limiting examples.

### EXAMPLES

The purpose of these Examples was to evaluate the performance of a thermoformable composite made from a combination of: (a) a fibrous filler component comprising a plurality of reinforcing fibers, (b) a fibrous thermoplastic fiber component comprising a plurality of thermoplastic fibers, and (c) an optional binder component comprising a plurality of polymeric binder fibers having a melt temperature lower than the thermoplastic fibers. In some embodiments, such composites meet all of the following requirements: (1) a peak heat release of less than 65 kW/m², as measured by FAR 25.853 (OSU test); (2) a total heat release at 2 minutes of less than or equal to 65 kW-min./m.2 as measured by FAR 25.853 (OSU test), (3) an NBS optical smoke density of less than 200 when measured at 4 minutes, based on ASTM E-662 (FAR/JAR 25.853).

Materials

The following materials were used in the Examples.

| MATERIAL | DESCRIPTION | SOURCE |
|---|---|---|
| Polyimide | | SABIC |
| fibers | | |
| LEXAN FST | Polysiloxane-polyestercarbonate | SABIC |
| fibers | copolymer fibers with polysiloxane units | |
| | having 4-50 siloxane units, and | |
| | polyestercarbonate units with 50 to 100 mol | |
| | % of arylate ester units, less than 50 mol | |
| | % aromatic carbonate units, less than | |
| | 30 mol % resorcinol carbonate units, and | |
| | less than 35 mol % bisphenol A carbonate | |
| | units | |
| Chopped Glass | ~½″ long, diameter of ~12 to 23 micron | OCF |
| fibers | | |
| Continuous | Strands of several hundred fibers 10 to | OCF |
| Carrier | 13 micron thick | |
| Carrier Layer | Lightweight (17 g/m²) glass fabric (106 | BFG |
| (scrim) | Weave) | |

Techniques/Procedures

Procedure for Determining Peak Heat Release and Total Heat Release at Two Minutes, as Measured by FAR 25.853 (OSU Test).

Heat release testing was performed using the Ohio State University (OSU) rate-of-heat release apparatus, by the method listed in FAR 25.853 (d), and in Appendix F, section IV (FAR F25.4). Peak heat release was measured as kW/m² (kilowatts per square meter). Total heat release was measured at the two minute mark in kW-min./m² (kilowatt minutes per square meter). The heat release test method is also described in the “Aircraft Materials Fire Test Handbook” DOT/FAA/AR-00/12, Chapter 5 “Heat Release Test for Cabin Materials.”

Procedure for Determining the NBS Optical Smoke Density at 4 Minutes, Based on ASTM E-662 (FAR/JAR 25.853).

Smoke density testing can be performed according to the method listed in FAR 25.853 (d), and in Appendix F, section V (FAR F25.5). Smoke density was measured under flaming mode. Smoke density at 4.0 minutes was determined.

Procedure for Draeger Tube Toxicity Testing.

Draeger tube toxicity of gases testing can be performed according to Airbus ABD0031 (also Boeing BSS 7238).

Procedure for Forming a Thermoformable Composite.

The composite was made according to the following process. The reinforcing fibers, polyimide fibers, and polymeric binder fibers were mixed in an aqueous slurry to form an aqueous suspension of the fiber mixture. The aqueous suspension was deposited on a wire mesh to form a layer, and water was drained from the layer to form a web.

The web was heated under conditions sufficient to remove any residual water and melt the binder fibers to form a matrix that was deposited onto the reinforcing and polyimide fiber surfaces, thereby forming a porous mat.

In the Comparative Examples, one or more layer(s) of the porous mat(s) were transferred onto a scrim carrier layer and the mat(s) on the scrim carrier layer were consolidated as described below.

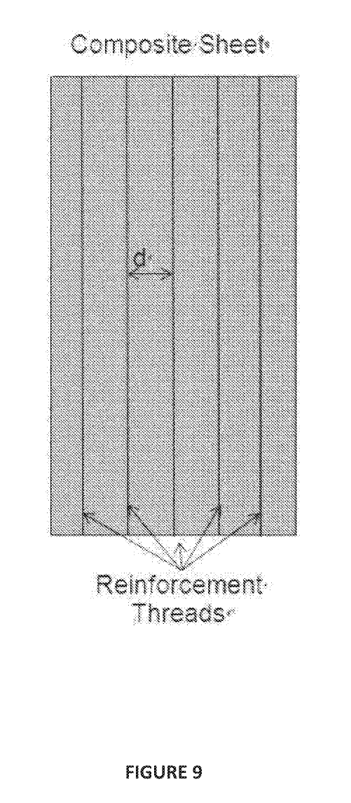

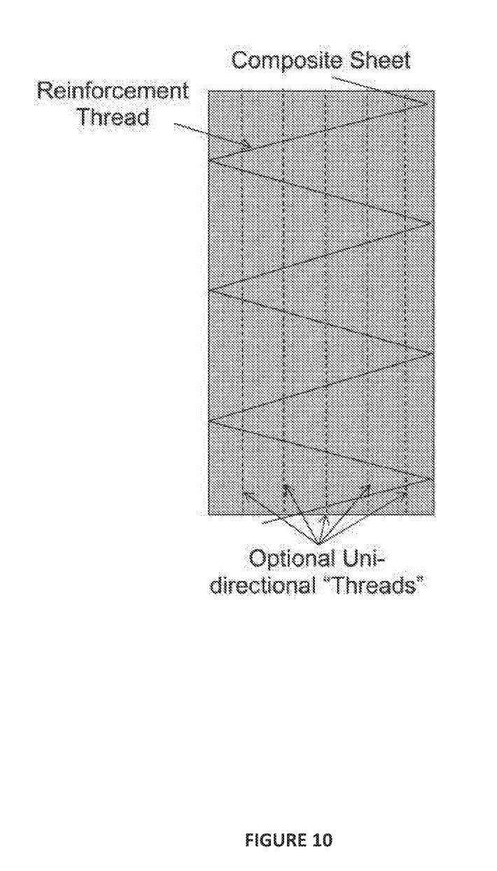

In the Examples hereof, continuous carrier fibers were directed along a surface of a porous mat to provide an array of spaced, continuous carrier fibers running along the surface of the mat. The spaced continuous carrier fibers were applied to the porous mat as yarn (yarn being the term for a bundle of fibers that is twisted together to hold them together for easy control) in the machine direction, as illustrated in FIG. 9. Alternatively, the carrier fiber can be applied to the porous mat in a diagonal traversing pattern, as illustrated in FIG. 10, in which the fiber traverses major portions of the width of the surface at an angle to the machine direction, and upon traversing its full sideward path of travel, returns back across the surface at an angle inclined toward the opposite edge of the surface of the porous mat.

The mats, once consolidated are the sheet that is reheated and formed. The carrier strands may be placed on top of a mat, between layers of mats, or under the bottom most layer of mat and consolidated (only once to minimize reinforcing and carrier fiber attrition) under conditions sufficient to melt the polyimide and compress the mat to form the thermoformable composite, such that the polyimide melted onto the reinforcing fiber surfaces and voids were minimized in number and size by compression and cooling under pressure to provide low porosity to the finished composite sheet.

Test to Determining Loft of Thermoformable Composite.

The following test procedure was used for determining degree of loft.

1. A 6 inch strip of the sheet was sheered for sampling from the consolidated sheet consolidated as described above once steady state of the consolidation was achieved.

2. Two-inch (50.8 mm) wide samples of the strip were cut. The samples were marked with sample numbers and the thickness was measured at 10 marked locations.

3. Subsequently the samples were placed in an oven at 380 degrees C. for 5 minutes.

4. After cooling, the thickness of all previously measured points of the samples was re-measured, averaged, and the ratios of the thickness after and before were recorded for each sample as degree of loft. Thickness and variability of thickness and degree of lofting were also calculated and recorded.

The degree of loft is a measure of how much the composite sheet expands and develops porosity on reheating substantially above the melt temperature of the matrix. Without being bound by theory, it is believed that expansion of the composite sheet is due to the reinforcing fibers being bent and trapped during consolidation and cooling. As the sheet is reheated (for example, during thermoforming), the reinforcing fibers can straighten as the viscosity of the matrix resin drops with increasing temperature. The extent to which the sheet can expand during heating (loft) is an indication of how well the sheet can be thermoformed. Too high a pressure or too low a temperature during consolidation will cause excessive breakage of the reinforcing fibers, resulting in poor expansion and reduced mechanical properties. Loft does not substantially affect the FST properties of the composite.

Procedure for Thermoforming the Composite into an Article.

The composite sheet was cut to the desired size and clamped into a clamp frame in a thermoformer. There it was exposed to heat from an emitter to bring the sheet to the proper forming temperature, e.g., about 365 degrees C. The tool, at a temperature of, e.g., about 175 degrees C., was then closed around the hot sheet. After approximately 1 minute, the cooled, formed part was removed from the tool and prepared for pulling the decorative surface film over the part. The formed part is prepared for application of a decorative film by trimming the formed part to the final desired dimension. Additional surface treatment such as filling, sanding, and priming can be used, but in an advantageous feature, are not required. The trimmed, formed part is then returned to the vacuum side of the tool (usually the bottom half). A decorative film is placed into the clamp frame and heated to a forming temperature, e.g., 140 degrees C. to 170 degrees C., at which point the film is pulled onto the trimmed part by bringing the trimmed part into contact with the hot film and drawing a vacuum through the lower half of the tool to remove any entrapped air. There is sufficient latent heat in the film, which contains hot melt adhesive on the underside to conform to the trimmed, formed part and bond securely to its surface. Upon cooling the part is ready for inspection.

Preparation of Consolidated Sheets.

Composites in the form of a consolidated sheet were made in accordance to the procedure above, using the same wt. % of glass fibers, cellulose nanofibers, polyimide fibers, and polysiloxane-polyestercarbonate copolymer fibers. Pressure during consolidation and loft are shown in Table 1. The temperature was kept at a constant 365 degrees C. during compression. Thermoformed articles were then made from the composites and tested to determine peak heat release, total heat release, and optical smoke density as described above.

TABLE 1

| | | | Consolidated | Lofted | Degree of |
|---|---|---|---|---|---|
| | Pressure | Rate** | thickness | thickness | Loft |
| Sample ID | Bar | M/min. | Mm | Mm | minimum |
| 1 | 20 | 0.5 | 1.00 | 3.47-3.98 | 3.6 |
| 2 | 30 | 0.5 | 0.85 | 2.7-4.3 | 3.2 |
| 3 | 10 | 1.0 | 1.10 | 4.6-4.9 | 4.2 |

**Rate (meters/minute) at which the mat was introduced into the heated belts during consolidation of the mat.

As can be seen from the results in Table 1, the composites had a minimum degree of loft greater than or equal to three.

Further, thermoformed articles were made from the composites and the thermoformed articles exhibited all of the following properties: (1) a peak heat release of less than 65 kW/m², as measured by FAR 25.853 (OSU test); (2) a total heat release at 2 minutes of less than or equal to 65 kW-min./m² as measured by FAR 25.853 (OSU test); and (3) an NBS optical smoke density of less than 200 when measured at 4 minutes, based on ASTM E-662 (FAR/JAR 25.853). Formability and mechanical strength were determined as well, and found to be acceptable.

Processing conditions were adjusted to provide similar ratios across the full width of the sheet. The composite was tested for its loft properties in accordance to the procedure described above. If the minimum degree of loft was found to be 3 or more and within one sigma above 3, the composite was determined to be within the required range.

TABLE 2

| | | | Consolidated | Lofted | Degree of |
|---|---|---|---|---|---|
| | Pressure | Rate | Thickness | Thickness | Loft |
| Ex. No. | Bar | m/min. | Mm | Mm | minimum |
| 9 | 20 | 0.5 | 0.86 | 3.22-3.36 | 3.74 |
| 10 | 20 | 1 | 0.85 | 3.45-3.54 | 4.04 |
| 11 | 10 | 1 | 0.93 | 4.13-4.32 | 4.17 |
| 12 | 10 | 1 | 0.93 | 3.76-4.63 | 4.04 |
| 13 | 10 | 1 | 0.97 | 4.08-4.9 | 4.21 |

Thermoformed articles were made from the indicated composites and the thermoformed articles each exhibited all of the following properties: (1) a peak heat release of less than 65 kW/m², as measured by FAR 25.853 (OSU test); (2) a total heat release at 2 minutes of less than or equal to 65 kW-min./m² as measured by FAR 25.853 (OSU test); and (3) an NBS optical smoke density of less than 200 when measured at 4 minutes, based on ASTM E-662 (FAR/JAR 25.853). The Examples further met the mechanical requirements for strength and stiffness as determined by a third party.

### Examples 14 to 21

Additional samples were run, varying the thermoplastic fiber and binder fiber as shown on Table

TABLE 3

| Example # | 14 | 15 | 16 | 17 | 18 | 19 | 20 | 21 |
|---|---|---|---|---|---|---|---|---|
| Composition | | | | | | | | |
| Fiberglass - % | OC | OC | OC | OC | OC | OC | OC | OC |
| | 40 | 40 | 40 | 40 | 40 | 40 | 40 | 40 |
| Resin - % | PPSU | PEI | 0 | PEI | PEI | PEI | Siltem | PEI |
| | 50 | 55 | 0 | 50 | 55 | 50 | 50% | 50 |
| Binder - % | FST | FST | FST | FST | PC 141 | PC 141 | FST | FST |
| | 10 | 5 | 60 | 10 | 5 | 10 | 10 | 10 |
| Toxicity - Draeger Tube | | | | | | | | |
| HCN (max. 150 ppm) | <1 | | <1 | <1 | <1 | | <1 | <1 |
| CO (max. 1000 ppm) | 112 | | 288 | 275 | 138 | | 200 | 100 |
| NO/NO₂ (max. 100 ppm) | 5 | | 3 | 10 | 5 | | 7 | 3 |
| SO₃ (max. 100 ppm) | 4 | | 5 | 3 | <1 | | 4 | <1 |
| HF (max. 100 ppm) | <1 | | <1 | <1 | <1 | | <1 | 4 |
| HCl (max. 150 ppm) | <1 | | <1 | <1 | <1 | | <1 | 1 |
| Pass/Fail | Pass | | Pass | Pass | Pass | | Pass | Pass |
| Flame Performance - | | | | | | | | |
| Vertical Burn (60 sec.) | | | | | | | | |
| Burn Time (max. 15 sec.) | 0 | 0 | 0 | 0 | 0 | 0 | 0 | 0 |
| Burn Length (max. 6 in.) | 1.4 | 1.7 | 1.6 | 1.8 | 1.8 | 1.6 | 4.4 | 1.8 |
| Longest Burn. Particle | None | None | None | None | None | None | None | None |
| (max. 3 sec.) | | | | | | | | |
| Pass/Fail | Pass | Pass | Pass | Pass | Pass | Pass | Pass | Pass |
| Flame Performance - | | | | | | | | |
| Smoke Density | | | | | | | | |
| Ds @ 1.5 m. | 2 | 3 | 11 | 0 | 4 | 10 | 32 | 0 |
| Ds @ 4 m. | 18 | 21 | 86 | 16 | 36 | 78 | 113 | 13 |
| Ds Maximum | 18 | 21 | 86 | 16 | 36 | 78 | 113 | 13 |
| D max. min. (200) | 3.57 | 3.57 | 3.58 | 3.54 | 3.58 | 3.59 | 3.69 | 3.57 |
| Pass/Fail | Pass | Pass | Pass | Pass | Pass | Pass | Pass | Pass |
| OSU Heat Release (65/65) | | | | | | | | |
| 2 min. Total (kW/m²) | 31 | 37 | 33 | 54 | 54 | 46 | 77 | 47 |
| Peak HR (kW/m²) | 30 | 32 | 30 | 39 | 44 | 36 | 54 | 37 |
| Peak Time (sec.) | 23 | 99 | 145 | 110 | 128 | 90 | 82 | 104 |
| Melting (Y/N) | No | No | No | No | No | No | No | No |
| Sagging (Y/N) | No | No | No | No | No | No | No | No |
| Dripping (Y/N) | No | No | No | No | No | No | No | No |
| 65/65 (Pass/Fail) | Pass | Pass | Pass | Pass | Pass | Pass | Fail | Pass |

3.

All references are incorporated herein by reference.

### Embodiment 1

A composition for the manufacture of a porous, compressible article, the composition comprising a combination of: a plurality of reinforcing fibers; and a plurality of thermoplastic fibers; wherein said combination of fibers is arranged in one or more layers; and spaced continuous carrier fibers are present on, and substantially transit, a surface of at least one such layer; and said composition does not contain a scrim carrier layer.

### Embodiment 2

The composition of Embodiment 1, wherein said spaced, continuous carrier fibers transit the surface of the layer as substantially parallel fibers in the machine direction.

### Embodiment 3

The composition of Embodiment 1, wherein said spaced, continuous carrier fibers transit the surface of the layer as substantially parallel fibers in the cross-machine direction.

### Embodiment 4

The composition of Embodiment 1, wherein the continuous carrier fiber traverses the surface of the layer in a zigzag manner, in which the fiber is oriented at an angle relative to the machine direction and transit a major portion of the cross-machine width of the surface of the layer and then return on a diagonal toward the opposite edge.

### Embodiment 5

The composition of any of the previous Embodiments, comprising: from 35 to 65 wt. % of the reinforcing fibers; and from 35 to 65 wt. % of the thermoplastic fibers; each based on the combined weight of the reinforcing fibers and the thermoplastic fibers.

### Embodiment 6

The composition of any of the previous Embodiments, wherein the reinforcing fibers comprise metal fibers, metallized inorganic fibers, metallized synthetic fibers, glass fibers, cellulose nanofibers, graphite or graphene fibers, carbon fibers, ceramic fibers, mineral fibers, basalt fibers, polymer fibers having a Tg at least 150 degrees C. higher than the polyimide, or a combination thereof.

### Embodiment 7

The composition of any of the previous Embodiments, wherein the reinforcing fibers comprise glass fibers.

### Embodiment 8

The composition of any of the previous Embodiments, wherein the thermoplastic fiber is selected from polyetherimide, polyetherimide sulfone, polyetherimide-siloxanes, polycarbonate, polycarbonate-siloxane, polyestercarbonate, polyestercarbonate-siloxane, polyesters, polyethylene terephthalate, polybutylene terephthalate, polyolefin, polyethylene, polypropylene, polyamides, and high performance polymers, polybenzimidazole, and liquid crystalline polymers.

### Embodiment 9

The composition of any of the previous Embodiments, wherein the thermoplastic fiber comprises a polyetherimide.

### Embodiment 10

The composition of any of the previous Embodiments, wherein the composition further comprises a polymeric binder fiber.

### Embodiment 11

The composition of Embodiment 10, wherein the polymeric binder fiber is selected from a polyamide, polysiloxane, polysiloxane-polyestercarbonate copolymer, polyester, polycarbonate, polyester-polyetherimide blend, bicomponent fiber of any of the foregoing, or a combination thereof.

### Embodiment 12

The composition of Embodiment 11, wherein the polysiloxane-polyestercarbonate copolymer comprises polysiloxane units comprising from 4 to 50 siloxane units, wherein the siloxane units are present in an amount of 0.2 to 10 wt. % of the total weight of the polysiloxane-polyestercarbonate copolymer, and polyester-polycarbonate units comprising, based on the polyester-polycarbonate units from 50 to 100 mole percent of arylate ester units, from more than 0 to less than 50 mole percent aromatic carbonate units, from more than 0 to less than 30 mole percent resorcinol carbonate units, and from more than 0 to less than 35 mole percent bisphenol carbonate units; and wherein the polysiloxane-polyestercarbonate copolymer composition has a 2 minute integrated heat release rate of less than or equal to 65 kilowatt-minutes per square meter (kW-min./m²) and a peak heat release rate of less than 65 kilowatts per square meter (kW/m²) as measured using the method of FAR F25.4, in accordance with Federal Aviation Regulation FAR 25.853 (d).

### Embodiment 13

The composition of Embodiment 11, wherein the arylate ester units are isophthalate-terephthalate-resorcinol ester units.

### Embodiment 14

The composition of any of the previous Embodiments, wherein the average fiber length of the discontinuous reinforcing fibers is from 5 to 75 millimeters and the average fiber diameter of the reinforcing fibers is from 5 to 125 micrometers; the average fiber length of the thermoplastic fibers is from 5 to 75 millimeters, and the average fiber diameter of the polyimide fibers is from 5 to 125 micrometers.

### Embodiment 15

The composition of any of the previous Embodiments, further comprising thermoplastic fibers of sub-micron diameter.

### Embodiment 16

The composition of any of the previous Embodiments, further comprising an aqueous fluid.

### Embodiment 17

A method for forming a porous article, the method comprising: forming a suspension of the composition of any of the previous Embodiments in liquid; at least partially removing the liquid from the suspension to form a web; heating the web under conditions sufficient to remove any remaining liquid from the web and to melt the thermoplastic; and cooling the heated web to form the porous mat, wherein the porous article comprises a network of the reinforcing fibers and the thermoplastic fibers.

### Embodiment 18

The method of Embodiment 17, wherein forming the web comprises: depositing the composition dispersed in an aqueous suspension onto a forming support element to form the layer; and evacuating the aqueous liquid to form the web, either by applying pressure or vacuum.

### Embodiment 19

The method of Embodiment 17, wherein the heating is at a temperature from 130 to 170 degrees C.

### Embodiment 20

The method of Embodiment 19, wherein the heating comprises drying in an oven at a temperature from 130 to 150 degrees C., then melting the binder via infrared heating at a temperature from 150 to 270 degrees C.

### Embodiment 21

A porous article comprising: a network of a plurality of reinforcing fibers and a plurality of thermoplastic fibers and a plurality of spaced continuous carrier fibers which substantially transit said porous article; and said porous article does not contain a scrim carrier layer.

### Embodiment 22

The porous article of Embodiment 21, having an areal weight of from 50 to 500 g/m².

### Embodiment 23

A method of forming a composite, the method comprising: heating and compressing at least one of the porous articles of Embodiment 21 under conditions sufficient to melt the thermoplastic fibers and consolidate the network; cooling the heated, compressed article under pressure to form the composite comprising: a network comprising a plurality of reinforcing fibers; and a matrix comprising melted and cooled thermoplastic, compositions, cellulose nanofiber composition and melted and cooled polymeric binder, wherein the polymeric binder has a melt temperature lower than the thermoplastic fiber.

### Embodiment 24

The method of Embodiment 23, comprising heating and compressing a stack comprising two or more of the porous mats.

### Embodiment 25

The method of Embodiment 23, comprising heating and compressing a stack comprising two to twelve of the porous mats.

### Embodiment 26

A thermoformable composite, comprising: a network comprising a plurality of reinforcing fibers; and a matrix comprising melted and cooled thermoplastic fibers and melted and cooled polymeric binder fibers, wherein the polymeric binder has a melt temperature lower than the thermoplastic, and a plurality of spaced continuous carrier fibers which substantially transit said porous article; and said porous article does not contain a scrim carrier layer; wherein the composite has a minimum degree of loft of greater than or equal to three.

### Embodiment 27

The composite of Embodiment 26, wherein the loft of the composite is within one sigma, over the entirety of the composite.

### Embodiment 28

The composite of any of the previous Embodiments, wherein the loft of the composite is within 30%, over the entirety of the composite.

### Embodiment 29

The composite of any of the previous Embodiments, having a melting point of at least 205 degrees C.

### Embodiment 30

The composition of any of the previous Embodiments, wherein a thermoformed article made from the composite has: a peak heat release of less than 65 kW/m², as measured by FAR 25.853 (OSU test); a total heat release at 2 minutes of less than or equal to 65 kW-min./m.2 as measured by FAR 25.853 (OSU test); and an NBS optical smoke density of less than 200 when measured at 4 minutes, based on ASTM E-662 (FAR/JAR 25.853).

### Embodiment 31

The composite of any of the previous Embodiments, further having a toxic gases release of less than or equal to 100 ppm based on Draeger Tube Toxicity test (Airbus ABD0031, Boeing BSS 7239).

### Embodiment 32

The composite of any of the previous Embodiments, wherein the composite does not include a flame retardant, wherein the flame retardant is a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.

### Embodiment 33

The composite of any of the previous Embodiments, further comprising a thermal stabilizer, an antioxidant, a light stabilizer, a gamma-irradiation stabilizer, a colorant, an antistatic agent, a lubricant, a mold release agent, or a combination thereof.

### Embodiment 34

A method of forming an article, the method comprising: thermoforming the composite of any of the previous Embodiments to form the article.

### Embodiment 35

The method of claim 34, wherein the thermoforming is match metal thermoforming.

### Embodiment 36

An article, comprising: a thermoformed composite of any of the previous Embodiments.

### Embodiment 37

The article of Embodiment 36, having a porosity from 30 to 200 volume % compared to the porosity of the composite.

### Embodiment 38

The article of claim 37, having a porosity from 50 to 100 volume % compared to the porosity of the composite.

### Embodiment 39

The article of Embodiment 37, wherein the article is selected from an aircraft interior panel, a train interior panel, an automobile interior panel, and a ship interior panel.

### Embodiment 40

A composite, comprising: a network comprising a plurality of reinforcing fibers selected from metal fibers, metallized inorganic fibers, metallized synthetic fibers, glass fibers, cellulose nanofibers, graphite or graphene fibers, carbon fibers, ceramic fibers, mineral fibers, basalt fibers, polymer fibers having a Tg at least 50 degrees C. higher than the processing temperature of the polyimide, and combinations thereof; and a matrix comprising: (a) melted and cooled polyimide fibers and (b) melted and cooled polymeric binder fibers, wherein the polymeric binder has a melt temperature lower than the polyimide, and a plurality of spaced continuous carrier fibers which substantially transit said composite; and said porous article does not contain a scrim carrier layer; wherein the composite has a minimum degree of loft of greater than or equal to three and the loft of the composite is within 30% over the entirety of the composite.

### Embodiment 41

The article of Embodiment 40, wherein the composite does not include a flame retardant, wherein the flame retardant is a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.

While typical embodiments have been set forth for the purpose of illustration, the foregoing descriptions should not be deemed to be a limitation on the scope herein. Accordingly, various modifications, adaptations, and alternatives can occur to a skilled artisan without departing from the spirit and scope herein.

It will be apparent to skilled artisans that various modifications and variations can be made in the containers, systems, and methods hereof, and the construction and components hereof, without departing from the scope or spirit of the present subject matter. It is intended that the specification and examples be considered as explanatory only, with a true scope and spirit of the present subject matter being indicated by the following claims.

What is claimed:

1. A diameter adjustable shipping container configured to be conformable to an interior space of an aircraft fuselage, the container having rounded exterior wall components, the rounded, exterior diameter adjustable shipping container comprising:
rounded exterior sidewall sections comprising a plurality of reinforcing fibers and carrier fibers arranged in one or more layers; wherein the reinforcing or carrier fibers comprise graphite or graphene or carbon fibers;
a base, a roof, at least two pair of opposed side walls comprising at least two of said exterior sidewall sections, and at least one pair of opposed end walls, one of said end walls including at least one opening for the loading and removal of freight, said shipping container and said opening configured to permit the loading and unloading of freight to and from the container by a conventional forklift truck;
wherein said shipping container is configured, with loaded freight as at least one freight loaded shipping container, truck or trailer, to be loaded and locked onto a freight truck or train for transport to an airport, and
wherein said at least one diameter adjustable shipping container is configured to be diameter adjusted, using a reconfiguration of said rounded exterior sidewall sections of said freight loaded shipping container, truck or trailer, to conform to at least a portion of said interior space of an aircraft fuselage adjacent to said freight loaded shipping container, truck or trailer when loaded onto said aircraft fuselage;

2. A diameter adjustable shipping container of claim 1, wherein at least one of the base, roof, and opposed side walls comprise a plurality of reinforcing fibers and carrier fibers arranged in one or more layers; wherein the reinforcing or carrier fibers comprise graphite or graphene or carbon fibers.

3. A diameter adjustable shipping container of claim 2, wherein the rounded exterior sidewall sections, or one or more of the base, the roof, and the at least two pair of opposed side walls, further comprise a plurality of thermoplastic fibers; and wherein said combination of one or more of reinforcing, carrier, and or thermoplastic fibers is arranged in one or more layers.

4. A diameter adjustable shipping container of claim 3, wherein the carrier fibers are configured to be present and spaced on, and substantially transit, a surface of at least one such layer; and said composition does not contain a scrim carrier layer.

5. A diameter adjustable shipping container of claim 4, wherein the spaced, continuous carrier fibers transit the surface of the layer as substantially parallel fibers in a machine or a cross-machine direction.

6. A diameter adjustable shipping container of claim 3, wherein the rounded exterior sidewall sections comprises: from 35 to 65 wt. % of the reinforcing fibers; and from 35 to 65 wt. % of the thermoplastic fibers; each based on the combined weight of the reinforcing fibers and the thermoplastic fibers.

7. A diameter adjustable shipping container of claim 1, wherein the reinforcing fibers further comprise one or more metal fibers, metallized inorganic fibers, metallized synthetic fibers, glass fibers, cellulose nanofibers, carbon fibers, ceramic fibers, mineral fibers, basalt fibers, or polymer fibers having a Tg at least 150 degrees C. higher than the polyimide, or a combination thereof.

8. A diameter adjustable shipping container of claim 1, wherein the reinforcing fibers comprise glass fibers.

9. A diameter adjustable shipping container of claim 3, wherein the thermoplastic fiber is selected from one or more of polyetherimide, polyetherimide sulfone, polyetherimide-siloxanes, polycarbonate, polycarbonate-siloxane, polyestercarbonate, polyestercarbonate-siloxane, polyesters, polyethylene terephthalate, polybutylene terephthalate, polyolefin, polyethylene, polypropylene, polyamides, and high performance polymers, polybenzimidazole, and liquid crystalline polymers.

10. A diameter adjustable shipping container of claim 3, wherein the thermoplastic fiber comprises a polyetherimide.

11. A diameter adjustable shipping container of claim 1, wherein the rounded exterior sidewall sections further comprises a polymeric binder fiber.

12. A method of shipping freight using at least one freight loaded shipping container, truck or trailer comprising a diameter adjustable shipping container according to claim 1, wherein the diameter adjustable shipping container is configured to be conformable to an interior space of an aircraft fuselage, the container having rounded exterior wall components, comprising the steps of:
(a) providing at least one diameter adjustable shipping container according to claim 1;
(b) adjusting that at least one diameter adjustable shipping container to be diameter adjusted, using a reconfiguration of said rounded exterior sidewall sections of said diameter adjustable shipping container, to conform to at least a portion of said interior space of an aircraft fuselage adjacent to said diameter adjustable shipping container when loaded onto said aircraft fuselage;
(c) loading freight into said at least one diameter adjustable shipping container adjusted according to step (b) and securing the freight in the rounded, exterior diameter adjustable shipping container to provide the at least one freight loaded shipping container, truck or trailer;
(d) transporting said at least one freight loaded shipping container, truck or trailer, in a secured state, to an aircraft comprising said aircraft fuselage;
(e) transferring and loading said at least one freight loaded shipping container, truck or trailer into said aircraft fuselage such that said freight loaded shipping container, truck or trailer conforms to at least a portion of said interior space of said aircraft fuselage adjacent to said freight loaded shipping container, truck or trailer when loaded onto said aircraft fuselage.

13. The method of claim 12, further comprising transporting by aircraft said at least one freight loaded shipping container to a designated airport; and transferring said at least one freight loaded shipping container, truck or trailer to a land vehicle.

14. The method of claim 12, further comprising the step of placing a bar code designation on the freight loaded shipping container, truck or trailer before it is transported according to step (d).

15. The method of claim 12, further comprising the step of placing transactional information regarding the freight and its intended destination into a computer memory.

16. The method of claim 12, wherein the method further comprises the step of transferring and transporting the at least one freight loaded shipping container, truck or trailer to and with a truck having a cab and a removable trailer, moving the removable trailer of the truck and the freight loading shipping container, driving the cab away, and returning and then picking up the removable trailer and freight loaded shipping container, truck or trailer after the freight loading shipping container is loaded.

17. A diameter adjustable shipping container of claim 9, wherein the polysiloxane-polyestercarbonate copolymer comprises polysiloxane units comprising from 4 to 50 siloxane units, wherein the siloxane units are present in an amount of 0.2 to 10 wt. % of the total weight of the polysiloxane-polyestercarbonate copolymer, and polyester-polycarbonate units comprising, based on the polyester-polycarbonate units from 50 to 100 mole percent of arylate ester units, from more than 0 to less than 50 mole percent aromatic carbonate units, from more than 0 to less than 30 mole percent resorcinol carbonate units, and from more than 0 to less than 35 mole percent bisphenol carbonate units; and wherein the polysiloxane-polyestercarbonate copolymer composition has a 2 minute integrated heat release rate of less than or equal to 65 kilowatt-minutes per square meter (kW-min/m²) and a peak heat release rate of less than 65 kilowatts per square meter (kW/m²) as measured using the method of FAR F25.4, in accordance with Federal Aviation Regulation FAR 25.853 (d).

18. A diameter adjustable shipping container of claim 9, wherein the average fiber length of the reinforcing fibers is from 5 to 75 millimeters and the average fiber diameter of the reinforcing fibers is from 5 to 125 micrometers; the average fiber length of the thermoplastic fibers is from 5 to 75 millimeters, and the average fiber diameter of the polyimide fibers is from 5 to 125 micrometers.

19. A diameter adjustable shipping container of claim 1, further comprising thermoplastic fibers of sub-micron diameter.

20. A diameter adjustable shipping container of claim 1, further comprising an aqueous fluid as the freight.
